(19) United States
(12) Patent Application Publication
(10) Pub. No.: US 2016/0349751 A1
(43) Pub. Date: Dec. 1, 2016

(54) AUTOMATIC DRIVING SYSTEM FOR VEHICLE

(71) Applicant: TOYOTA JIDOSHA KABUSHIKI KAISHA, Toyota-shi (JP)

(72) Inventor: Kazuhiro SUGIMOTO, Susono-shi, Shizuoka-ken (JP)

(73) Assignee: TOYOTA JIDOSHA KABUSHIKI KAISHA, Toyota-shi (JP)

(21) Appl. No.: 15/159,354

(22) Filed: May 19, 2016

(30) Foreign Application Priority Data
May 25, 2015 (JP) 2015-105555

(51) Int. Cl. G05D 1/00; G01S 19/13; G05D 1/02; G01C 21/36

(52) U.S. Cl. CPC G05D 1/0088; G01C 21/36; G01S 19/13; G05D 1/0257; G05D 1/0248; G05D 1/0223; G05D 2201/0213

(57) ABSTRACT

An automatic driving system for a vehicle includes an external sensor and an electronic control unit. The electronic control unit is configured to estimate whether the vehicle peripheral information detected by the external sensor allows the vehicle to keep a vehicle target speed set on the basis of a vehicle travel plan or temporarily does not allow the vehicle to keep the vehicle target speed. The electronic control unit is configured to, when it is estimated that the vehicle peripheral information temporarily does not allow the vehicle to keep the vehicle target speed, generate a plurality of vehicle travel plans during a travel duration for which it is estimated that the vehicle peripheral information temporarily does not allow the vehicle to keep the vehicle target speed, and select one of the plurality of vehicle travel plans, which provides a lowest fuel consumption of an engine.

### INCORPORATION BY REFERENCE

The disclosure of Japanese Patent Application No. 2015-105555 filed on May 25, 2015 including the specification, drawings and abstract is incorporated herein by reference in its entirety.

### BACKGROUND OF THE INVENTION

1. Field of the Invention

The invention relates to an automatic driving system for a vehicle.

2. Description of Related Art

There is known an automatic driving system for a vehicle (see, for example, Japanese Patent Application Publication No. 2008-129804 (JP 2008-129804 A).

The automatic driving system includes an external sensor for detecting vehicle peripheral information. The automatic driving system generates a vehicle travel plan along a preset target route on the basis of map information and the vehicle peripheral information detected by the external sensor, and controls automatic driving of the vehicle on the basis of the generated vehicle travel plan. With this automatic driving system, the vehicle travel plan is generated in consideration of the safety and fuel economy of the vehicle.

### SUMMARY OF THE INVENTION

However, JP 2008-129804 A does not specifically describe how fuel consumption is reduced during automatic driving. Therefore, it is not clear how to reduce fuel consumption during automatic driving. The invention provides an automatic driving system for a vehicle, which shows a specific technique for reducing fuel consumption during automatic driving.

An aspect of the invention provides an automatic driving system for a vehicle. The automatic driving system includes an external sensor and an electronic control unit. The external sensor detects vehicle peripheral information. The electronic control unit is configured to generate a vehicle travel plan along a preset target route on a basis of map information and the vehicle peripheral information detected by the external sensor. The electronic control unit is configured to control automatic driving of the vehicle on a basis of the vehicle travel plan. The electronic control unit is configured to estimate whether the vehicle peripheral information detected by the external sensor allows the vehicle to keep a vehicle target speed set on a basis of the vehicle travel plan or temporarily does not allow the vehicle to keep the vehicle target speed. The electronic control unit is configured to, when it is estimated that the vehicle peripheral information temporarily does not allow the vehicle to keep the vehicle target speed, generate a plurality of vehicle travel plans during a travel duration for which it is estimated that the vehicle peripheral information temporarily does not allow the vehicle to keep the vehicle target speed, and select one of the plurality of vehicle travel plans, which provides a lowest fuel consumption of an engine. The electronic control unit is configured to, during the travel duration for which it is estimated that the vehicle peripheral information temporarily does not allow the vehicle to keep the vehicle target speed, control driving of the engine and driving of a steering apparatus in accordance with the selected one of the vehicle travel plans.

With the automatic driving system according to the above aspect, when it is estimated that the vehicle peripheral information temporarily does not allow the vehicle to keep the vehicle target speed, the vehicle travel plan that provides the lowest fuel consumption is generated, and it is possible to appropriately reduce fuel consumption by causing the vehicle to travel on the basis of the generated vehicle travel plan. In the automatic driving system according to the above aspect, the electronic control unit may be configured to, when the host vehicle is not allowed to travel at the vehicle target speed due to another vehicle ahead of the host vehicle in a traveling direction of the host vehicle, estimate that the vehicle peripheral information temporarily does not allow the host vehicle to keep the vehicle target speed set on the basis of the vehicle travel plan. In the automatic driving system according to the above aspect, the electronic control unit may be configured to, when a host vehicle is not allowed to travel at the vehicle target speed due to the other vehicle ahead of the host vehicle in the traveling direction of the host vehicle and when a distance between the host vehicle and the other vehicle ahead of the host vehicle in the traveling direction of the host vehicle is shorter than or equal to a predetermined distance, estimate that the vehicle peripheral information temporarily does not allow the host vehicle to keep the vehicle target speed set on a basis of the vehicle travel plan. In the automatic driving system according to the above aspect, the electronic control unit may be configured to, when there are at least two adjacent cruising lanes, the host vehicle is traveling in one of the cruising lanes and it is estimated that the vehicle peripheral information temporarily does not allow the host vehicle to keep the vehicle target speed set on a basis of the vehicle travel plan, generate the vehicle travel plan, including a vehicle travel plan in which the host vehicle continues traveling in the one of the cruising lanes and a vehicle travel plan in which the host vehicle makes a lane change to the other one of the cruising lanes. In the automatic driving system according to the above aspect, the electronic control unit may be configured to, when the host vehicle is not allowed to travel at the vehicle target speed due to another vehicle ahead of the host vehicle in a traveling direction of the host vehicle in the one of the cruising lanes, estimate that the vehicle peripheral information temporarily does not allow the host vehicle to keep the vehicle target speed set on a basis of the vehicle travel plan. In the automatic driving system according to the above aspect, the electronic control unit may be configured to generate a vehicle travel plan during the travel duration for which it is estimated that the vehicle peripheral information temporarily does not allow the vehicle to keep the vehicle target speed on a basis of a signal received from a traffic light arranged at a road, the signal regarding time at which the traffic light turns from red to green and time at which the traffic light turns from green to red. In the automatic driving system according to the above aspect, the electronic control unit may be configured to, for each of the vehicle travel plans, calculate a change in engine output torque and a change in engine rotation speed during the travel duration for which it is estimated that the vehicle peripheral information temporarily does not allow the vehicle to keep the vehicle target speed and then calculate an estimated fuel consumption during the travel duration for which it is estimated that the vehicle peripheral information temporarily does not allow the vehicle to keep the vehicle target speed on a basis of the change in engine output torque and the change in engine rotation speed. In the automatic driving system according to the above aspect, the electronic control unit may be configured to calculate a vehicle travel distance during the travel duration for which it is estimated that the vehicle peripheral information temporarily does not allow the vehicle to keep the vehicle target speed, the electronic control unit may be configured to calculate a reference fuel consumption on an assumption that the vehicle has traveled the vehicle travel distance at the vehicle target speed, the electronic control unit may be configured to select one of the vehicle travel plans, by which an amount of increase in estimated fuel consumption with respect to the reference fuel consumption is minimum or an amount of reduction in estimated fuel consumption with respect to the reference fuel consumption is maximum, the electronic control unit may be configured to, during the travel duration for which it is estimated that the vehicle peripheral information temporarily does not allow the vehicle to keep the vehicle target speed, control driving of the engine and driving of the steering apparatus in accordance with the selected one of the vehicle travel plans.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram that shows the configuration of an automatic driving system for a vehicle;

FIG. 2 is a side view of the vehicle;

FIG. 3 is a view for illustrating the path of a course of the host vehicle;

FIG. 4 is a view for illustrating the paths of courses of the host vehicle;

FIG. 5 is a flowchart for generating a travel plan;

FIG. 6 is a flowchart for executing traveling control;

FIG. 7A is a view that shows a road condition, a vehicle speed of the vehicle and a required driving torque of the vehicle;

FIG. 7B is a view for illustrating a method of calculating a required driving torque of the vehicle;

FIG. 7C is a view for illustrating a method of calculating a required driving torque of the vehicle during traveling on an uphill road;

FIG. 8 is a control structure of engine driving control based on a vehicle travel plan;

FIG. 9A is a view that shows an entire engine and a steering apparatus;

FIG. 9B is a view that shows a map that is used to calculate a speed ratio of an automatic transmission as a function of a required driving torque and a vehicle speed;

FIG. 10 is a time chart that shows changes in vehicle speed, engine rotation speed, engine output torque, and the like;

FIG. 11 is a view that shows an example of a vehicle travel pattern;

FIG. 12 is a time chart that shows changes in fuel consumption, and the like, at the time when the vehicle travel plan is generated in pattern A shown in FIG. 11;

FIG. 13 is a time chart that shows changes in fuel consumption, and the like, at the time when the vehicle travel plan is generated in pattern B shown in FIG. 11;

FIG. 14 is a time chart that shows changes in fuel consumption, and the like, at the time when the vehicle travel plan is generated in pattern C shown in FIG. 11;

FIG. 15 is a graph that shows fuel consumption per unit travel distance;

FIG. 16 is a view that shows another example of the vehicle travel pattern;

FIG. 17 is a time chart that shows changes in fuel consumption, and the like, at the time when the vehicle travel plan is generated in pattern A shown in FIG. 16;

FIG. 18 is a time chart that shows changes in fuel consumption, and the like, at the time when the vehicle travel plan is generated in pattern B shown in FIG. 16;

FIG. 19 is a time chart that shows changes in fuel consumption, and the like, at the time when the vehicle travel plan is generated in pattern C shown in FIG. 16;

FIG. 20 is a graph that shows fuel consumption per unit travel distance;

FIG. 21 is a flowchart for generating a vehicle travel plan;

FIG. 22A is a flowchart that shows one example of portion A in FIG. 21; and

FIG. 22B is a flowchart that shows another example of portion A in FIG. 21.

### DETAILED DESCRIPTION OF EMBODIMENTS

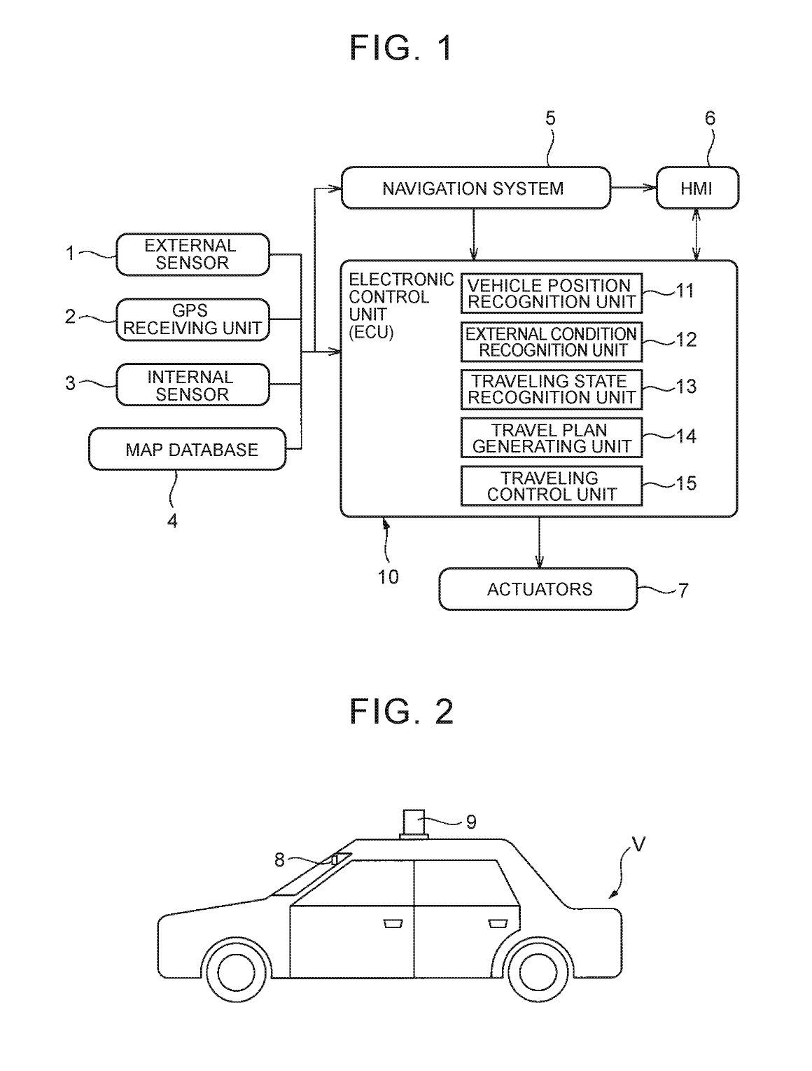

FIG. 1 is a block diagram that shows the configuration of an automatic driving system for a vehicle, which is mounted on a vehicle, such as an automobile. As shown in FIG. 1, the automatic driving system for a vehicle includes an external sensor 1, a global positioning system (GPS) receiving unit 2, an internal sensor 3, a map database 4, a navigation system 5, a human machine interface (HMI) 6, various actuators 7, and an electronic control unit (ECU) 10. The external sensor 1 detects vehicle peripheral information.

In FIG. 1, the external sensor 1 is a detection device for detecting an external condition that is peripheral information around the vehicle V. The external sensor 1 includes at least one of a camera, a radar and a laser imaging detection and ranging (LIDAR). For example, as denoted by reference numeral 8 in FIG. 2, the camera is provided on the back side of a windshield of the vehicle V. The camera 8 captures an image ahead of the vehicle V. Information captured by the camera 8 is transmitted to the electronic control unit 10. On the other hand, the radar is a device that detects an obstacle outside the vehicle V by utilizing radio waves. The radar detects an obstacle around the vehicle V on the basis of a reflected wave of radio waves irradiated from the radar to around the vehicle V. Obstacle information detected by the radar is transmitted to the electronic control unit 10.

The LIDAR is a device that detects an obstacle outside the vehicle V by utilizing laser light. For example, as denoted by reference numeral 9 in FIG. 2, the LIDAR is installed on the roof of the vehicle V. The LIDAR 9 measures a distance from a reflected light of laser light, sequentially irradiated toward all directions around the vehicle V, to an obstacle. An obstacle in any direction around the vehicle V is detected in three-dimensional form. Three-dimensional obstacle information detected by the LIDAR 9 is transmitted to the electronic control unit 10.

In FIG. 1, the GPS receiving unit 2 receives signals from three or more GPS satellites, and detects the position of the vehicle V (for example, the latitude and longitude of the vehicle V) on the basis of the received signals. Positional information of the vehicle V, detected by the GPS receiving unit 2, is transmitted to the electronic control unit 10.

In FIG. 1, the internal sensor 3 is a detection device for detecting a traveling state of the vehicle V. The internal sensor 3 includes at least one of a vehicle speed sensor, an acceleration sensor and a yaw rate sensor. The vehicle speed sensor is a detector that detects a speed of the vehicle V. The acceleration sensor is, for example, a detector that detects a longitudinal acceleration of the vehicle V. The yaw rate sensor is a detector for detecting a rotational angular velocity around a vertical axis at the center of gravity of the vehicle V. Pieces of information, detected by these vehicle speed sensor, acceleration sensor and yaw rate sensor, are transmitted to the electronic control unit 10.

In FIG. 1, the map database 4 is a database for map information. The map database 4 is, for example, stored in a hard disk drive (HDD) mounted on the vehicle. The map information includes, for example, positional information of roads, information of road shapes (such as classifications of curve and straight portion and the curvatures of curves) and positional information of intersections and branching points. In an embodiment shown in FIG. 1, three-dimensional basic data of external fixed obstacles are stored in the map database 4. The three-dimensional basic data of the external fixed obstacles are generated with the use of the LIDAR 9 at the time when the vehicle is caused to travel in the center of a cruising lane.

In FIG. 1, the navigation system 5 is a device that guides a driver of the vehicle V to a destination set by the driver of the vehicle V. The navigation system 5 computes a target route to the destination on the basis of the map information of the map database 4 and the current position of the vehicle V, measured by the GPS receiving unit 2. Information about the target route of the vehicle V is transmitted to the electronic control unit 10.

In FIG. 1, the HMI 6 is an interface for the output and input of information between an occupant of the vehicle V and the automatic driving system for a vehicle. The HMI 6 includes, for example, a display panel for displaying image information for the occupant, a speaker for audio output, operation buttons or touch panel for the occupant to perform input operation, and the like. When the occupant performs input operation to start automatic driving through the HMI 6, a signal is transmitted to the electronic control unit 10, and then automatic driving is started. When the occupant performs input operation to stop automatic driving, a signal is transmitted to the ECU 10, and then automatic driving is stopped.

In FIG. 1, the actuators 7 are provided in order to execute traveling control over the vehicle V. The actuators 7 include at least an accelerator actuator, a brake actuator and a steering actuator. The accelerator actuator controls a throttle opening degree in response to a control signal from the electronic control unit 10, thus controlling driving force of the vehicle V. The brake actuator controls a depression amount of a brake pedal in response to a control signal from the electronic control unit 10, thus controlling braking force that is applied to wheels of the vehicle V. The steering actuator controls driving of a steering assist motor of an electric power steering system in response to a control signal from the electronic control unit 10, thus controlling steering action of the vehicle V.

The electronic control unit 10 includes a central processing unit (CPU), a read only memory (ROM), a random access memory (RAM), and the like, that are connected with one another via a bidirectional bus. FIG. 1 shows the case where the single electronic control unit 10 is used. Instead, a plurality of electronic control units may be used. As shown in FIG. 1, the electronic control unit 10 includes a vehicle position recognition unit 11, an external condition recognition unit 12, a traveling state recognition unit 13, a travel plan generating unit 14 and a traveling control unit 15.

In the embodiment according to the invention, the vehicle position recognition unit 11 recognizes an initial position of the vehicle V on a map at the start of automatic driving on the basis of the positional information of the vehicle V, received by the GPS receiving unit 2. When the initial position of the vehicle V at the start of automatic driving is recognized, the external condition recognition unit 12, after that, recognizes an external condition of the vehicle V and an accurate position of the vehicle V. That is, the external condition recognition unit 12 recognizes the external condition of the vehicle V on the basis of a detected result (such as captured information of the camera 8, obstacle information from the radar and obstacle information from the LIDAR 9) of the external sensor 1. In this case, the external condition includes the position of a white line of the cruising lane with respect to the vehicle V, the position of a lane center with respect to the vehicle V, a road width, a road shape (such as the curvature of the cruising lane and a change in the gradient of a road surface) and the condition of an obstacle around the vehicle V (such as information that discriminates a fixed obstacle and a movable obstacle from each other, the position of an obstacle with respect to the vehicle V, the moving direction of an obstacle with respect to the vehicle V and the relative velocity of an obstacle with respect to the vehicle V).

When the initial position of the vehicle V at the start of automatic driving has been recognized on the basis of the positional information of the vehicle V, received by the GPS receiving unit 2, the external condition recognition unit 12 recognizes the current accurate position of the vehicle V by comparing the three-dimensional basic data of external fixed obstacles stored in the map database 4 by the LIDAR 9 with the current three-dimensional detection data of fixed obstacles outside the vehicle V, detected by the

LIDAR 9. Specifically, an image position in which three-dimensional images of the external fixed obstacles detected by the LIDAR 9 completely overlap with the three-dimensional basic images of the stored external fixed obstacles is located while shifting the three-dimensional images little by little, and the amount of shift of the three-dimensional images at this time indicates the amount of shift from the center of the cruising lane of the vehicle. Therefore, it is possible to recognize the current accurate position of the vehicle V on the basis of this amount of shift.

When the amount of shift from the center of the cruising lane of the vehicle is obtained in this way, travel of the vehicle is controlled such that the vehicle travels in the center of the cruising lane at the start of automatic driving of the vehicle. A job for locating an image position in which the three-dimensional images of the external fixed obstacles detected by the LIDAR 9 completely overlap with the three-dimensional basic images of the stored external fixed obstacles is continued during traveling in the lane, and travel of the vehicle is controlled such that the vehicle travels in the center of the cruising lane along a target route set by a driver. The external condition recognition unit 12 recognizes movable obstacles, such as pedestrians, by comparing the three-dimensional images of the external obstacles (fixed obstacles and movable obstacles) detected by the LIDAR 9 with the three-dimensional basic images of the stored external fixed obstacles.

The traveling state recognition unit 13 recognizes the traveling state of the vehicle V on the basis of a detected result (such as vehicle speed information from the vehicle speed sensor, acceleration information from the acceleration sensor and rotation angular velocity information from the yaw rate sensor) of the internal sensor 3. The traveling state of the vehicle V includes, for example, a vehicle speed, an acceleration, and a rotation angular velocity around the vertical axis at the center of gravity of the vehicle V.

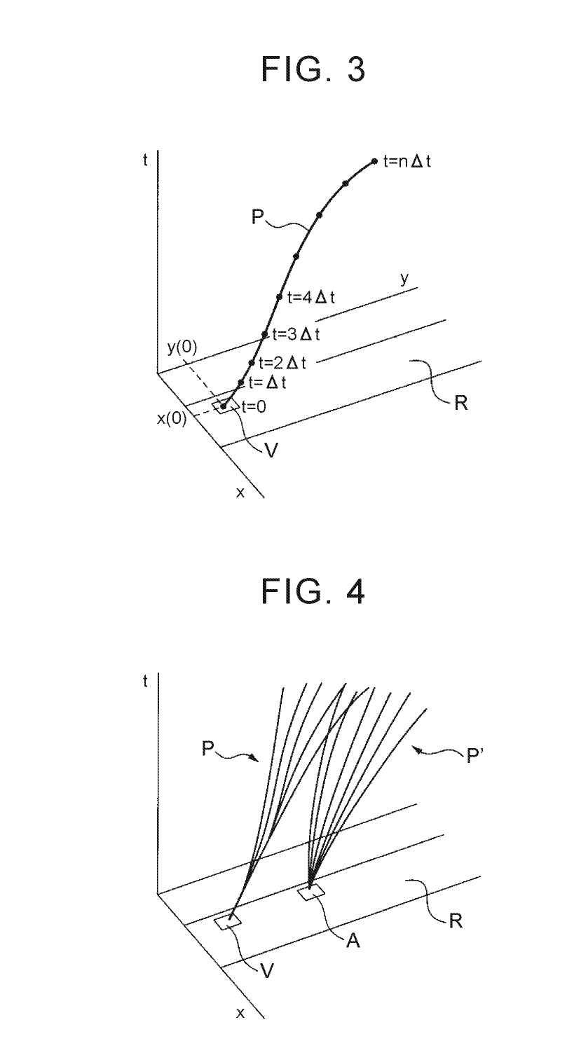

The travel plan generating unit 14 generates a travel plan of the host vehicle V along the target route set by the driver, that is, determines the course of the host vehicle, on the basis of the map information of the map database 4, the position of the host vehicle V, recognized by the vehicle position recognition unit 11 and the external condition recognition unit 12, the external condition of the host vehicle V (such as the position and traveling direction of another vehicle), recognized by the external condition recognition unit 12, the speed and acceleration of the host vehicle V, detected by the internal sensor 3, and the like. In this case, the course is determined such that the vehicle reaches a destination safely in the shortest period of time while complying with laws and regulations. Next, a manner of determining the course will be simply described with reference to FIG. 3 and FIG. 4.

FIG. 3 and FIG. 4 show a three-dimensional space in which an axis orthogonal to an xy-plane is set as a time axis t. In FIG. 3, V denotes the host vehicle on the xy-plane, and the y-axis direction in the xy-plane is the traveling direction of the host vehicle V. In FIG. 3, R denotes a road on which the host vehicle V is currently traveling. As indicated by P in FIG. 3, the travel plan generating unit 14 generates a future path of a course of the host vehicle V within the three-dimensional space formed of xyz axes. An initial position of the path is the current position of the host vehicle V, time t at this time is set to zero (time t =0), and the position of the host vehicle V at this time is set to (x(0), y(0)). The traveling state of the host vehicle V is expressed by a vehicle speed v and a traveling direction 0, and the traveling state of the host vehicle V at time t=0 is set to (v(0), θ(0)).

Driving operation that is performed on the host vehicle V in the course of a period of Δt time (0.1 to 0.5 seconds) from time t=0 is selected from among a plurality of operations set in advance. Specific examples include selecting from among a plurality of values set in advance within the range of −10 to +30 Km/h/sec for acceleration and selecting from among a plurality of values set in advance within the range of −7 to +7 degrees/sec for steering angle. In this case, for example, for each combination of any one of accelerations and any one of steering angles, the position (x(1), y(1)) of the host vehicle

V and the traveling state (v(1), θ(1)) of the host vehicle V after a period of Δt (t =Δt) are obtained, and subsequently, further after a period of Δt, that is, after a period of 2Δt (t =2Δt) the position (x(2), y(2)) of the host vehicle V and the traveling state (v(2), θ(2)) of the host vehicle V are obtained. Similarly, the position (x(n), y(n)) of the host vehicle V and the traveling state (v(n), θ(n)) of the host vehicle V after a period of nΔt (t=nΔt) are obtained.

The travel plan generating unit 14 generates a plurality of paths of courses by connecting the positions (x, y) of the host vehicle V, which are obtained respectively for combinations of any one of accelerations and any one of steering angles. P in FIG. 3 represents a typical one of the thus obtained paths. When a plurality of paths of courses are generated, the path along which the vehicle can reach a destination safely in the shortest period of time while complying with laws and regulations is selected from among these paths, and the selected path is determined as the course of the host vehicle V. In FIG. 3, a projection drawing to the xy-plane on the road R of this path is the actual course of the host vehicle V.

Next, an example of a method of selecting the path along which the vehicle can reach a destination safely in the shortest period of time from among a plurality of paths of courses while complying with laws and regulations will be described with reference to FIG. 4. In FIG. 4, V denotes the host vehicle as well as FIG. 3, and A denotes another vehicle that is traveling ahead of the host vehicle V in the same direction as the host vehicle V. FIG. 4 shows a plurality of paths P of courses generated for the host vehicle V. The travel plan generating unit 14 also generates a plurality of paths of courses for combinations of any one of accelerations and any one of steering angles for the other vehicle A. The plurality of paths of courses generated for the other vehicle A are denoted by P′ in FIG. 4.

The travel plan generating unit 14 initially determines for each of the paths P whether the host vehicle V can travel within the road R and whether the host vehicle V does not collide with any fixed obstacle or any pedestrian when the host vehicle V travels in accordance with the intended path P on the basis of external information recognized by the external condition recognition unit 12. When it is determined that the host vehicle V cannot travel within the road R or it is determined that the host vehicle V collides with a fixed obstacle or a pedestrian if the host vehicle V travels in accordance with the intended path P, the intended path P is excluded from choices, and the degree of interference with the other vehicle A is determined for the remaining paths P.

That is, in FIG. 4, when the path P intersects with the path P′, it means that the host vehicle V and the other vehicle A collide with each other at time t at which the path P intersects with the path P′. Therefore, in the case where the simplest determination method is used, when there is a path that intersects with any one of the paths P′ among the above-described remaining paths P, the path P that intersects with the any one of the paths P′ is excluded from choices, and a path P along which the vehicle can reach a destination in the shortest period of time is selected from among the remaining paths P. In this case, the determination method becomes slightly complicated; however, even when any one of the paths P intersects with any one of the paths P′, a selecting method for selecting a path P along which the degree of collision is low as an optimal path may be employed. In this way, a path P along which the vehicle can reach a destination safely in the shortest period of time while complying with laws and regulations is selected from among a plurality of paths P of courses.

When the path P is selected, the travel plan generating unit 14 outputs the position (x(1), y(1)) of the host vehicle V and the traveling state (v(1), θ(1)) of the host vehicle V at time t=Δt in the selected path P, the position (x(2), y(2)) of the host vehicle V and the traveling state (v(2), θ(2)) of the host vehicle V at time t=2Δt in the selected path P, . . . , and the position (x(n), y(n)) of the host vehicle V and the traveling state (v(n), θ(n)) of the host vehicle V at time t=nΔt in the selected path P. The traveling control unit 15 controls travel of the host vehicle on the basis of these positions of the host vehicle V and these traveling states of the host vehicle V.

Subsequently, at time t=Δt, where time t at this time is zero (time t=0), the position of the host vehicle V is (x(0), y(0)) and the traveling state of the host vehicle V is (v(0), θ(0)), a plurality of paths P of courses are generated again for combinations of any one of accelerations and any one of steering angles, and an optimal path P is selected from among these paths P. When the optimal path P is selected, the travel plan generating unit 14 outputs the position of the host vehicle V and the traveling state of the host vehicle V at each of time t=Δt, 2Δt, . . . , and nΔt in the selected path P, and the traveling control unit 15 controls travel of the host vehicle on the basis of these positions of the host vehicle V and these traveling states of the host vehicle V. After that, this will be repeated.

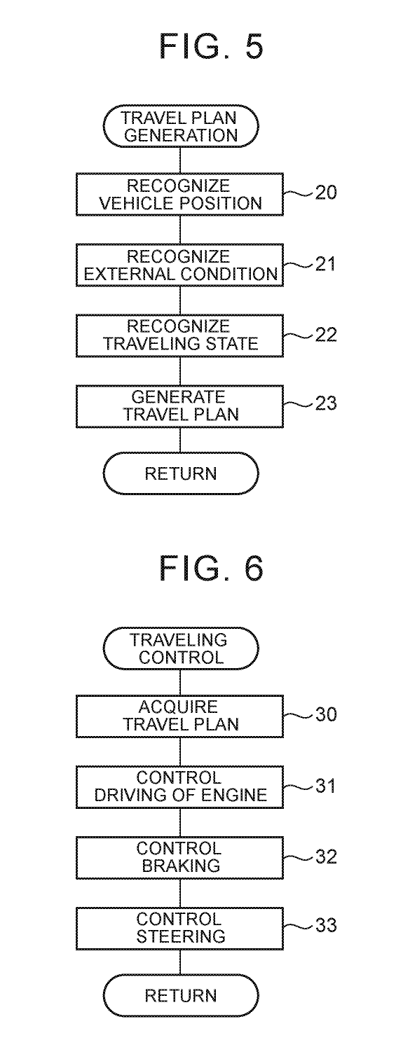

Next, a basic process that is executed in the automatic driving system for a vehicle will be simply described with reference to the flowcharts shown in FIG. 5 and FIG. 6. For example, when the driver sets a destination in the navigation system 5 and performs input operation to start automatic driving through the HMI 6, the electronic control unit 10 repeatedly executes the routine of generating a travel plan, as shown in FIG. 5.

That is, initially, in step 20, the vehicle position recognition unit 11 recognizes the position of the host vehicle V on the basis of the positional information of the vehicle V, received by the GPS receiving unit 2. Subsequently, in step 21, the external condition recognition unit 12 recognizes the external condition of the host vehicle V and the accurate position of the host vehicle V on the basis of the detected result of the external sensor 1. Subsequently, in step 22, the traveling state recognition unit 13 recognizes the traveling state of the vehicle V on the basis of the detected result of the internal sensor 3. Subsequently, in step 23, the travel plan generating unit 14 generates a travel plan of the vehicle V in the manner described with reference to FIG. 3 and FIG. 4. Traveling control over the vehicle is executed on the basis of the travel plan. The routine for executing the traveling control over the vehicle is shown in FIG. 6.

As shown in FIG. 6, initially, in step 30, the travel plan generated by the travel plan generating unit 14, that is, the position (x, y) of the host vehicle V and the traveling state (v, θ) of the host vehicle V at each time from t=Δt to t=nΔt in the selected path P are loaded. Subsequently, on the basis of the position (x, y) of the host vehicle V and the traveling state (v, θ) of the host vehicle V at each time, driving control over the engine of the vehicle V, control over engine auxiliaries, and the like, are executed in step 31, braking control over the vehicle V, lighting control over brake lamps, and the like, are executed in step 32, and steering control, control over direction indicator lamps, and the like, are executed in step 33. These controls are updated in step 30 each time an updated new travel plan is acquired.

In this way, automatic driving of the vehicle V in accordance with the generated travel plan is performed. When automatic driving of the vehicle V is performed and then the vehicle V has reached a destination, or when input operation to stop automatic driving has been performed by the driver through the HMI 6 while automatic driving of the vehicle V is being performed, automatic driving is ended.

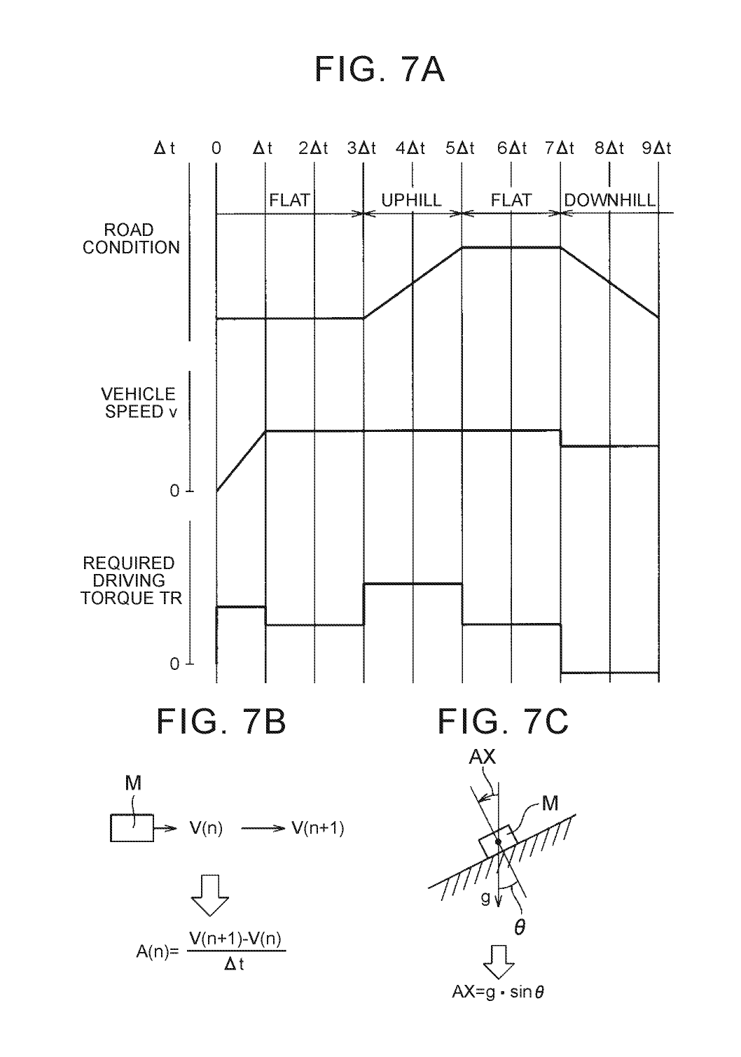

Next, an example of driving control over the engine of the vehicle V based on the travel plan generated by the travel plan generating unit 14 will be schematically described with reference to FIG. 7A. FIG. 7A shows a road condition, a vehicle speed v of the vehicle V and a required driving torque TR of the vehicle V. In FIG. 7A, the vehicle speed v shows an example of a vehicle speed based on the travel plan generated by the travel plan generating unit 14. The example shown in FIG. 7A shows the case where the vehicle V is stopped at time t=0, the vehicle V is accelerated in the course of a period from time t=0 to time t=Δt, the vehicle V is caused to travel at a constant speed even when the road becomes an uphill road in the middle of a period from time t=Δt to time t=7Δt, and the vehicle speed v is decreased on a downhill road from time t=7Δt.

In the embodiment according to the invention, an acceleration A(n) in the traveling direction of the vehicle V to be added to the vehicle V is obtained from the vehicle speed v based on the travel plan generated by the travel plan generating unit 14, the required driving torque TR of the vehicle V is obtained from the acceleration A(n), and the engine is subjected to driving control such that driving torque of the vehicle V becomes the required driving torque TR. For example, as shown in FIG. 7B, where the vehicle having a mass of M is accelerated from v(n) to v(n+1) in the course of the period of time Δt, the acceleration A(n) in the traveling direction of the vehicle V at this time is expressed by Acceleration A(n)=(v(n+1)−v(n))/Δt, as shown in FIG. 7B. Where force that acts on the vehicle V at this time is denoted by F, the force F is expressed by the product of the mass M of the vehicle V and the acceleration A(n) (=M·A(n)). On the other hand, where the radius of each drive wheel of the vehicle V is denoted by r, the driving torque TR of the vehicle V is expressed by F·r. Therefore, the required driving torque TR of the vehicle V is expressed by C·A(n) (=F·r=M·A(n)·r) where C is constant.

When the required driving torque TR (=C·A(n)) of the vehicle V is obtained, the engine is subjected to driving control such that the driving torque of the vehicle V becomes the required driving torque TR. Specifically, engine output torque and the speed ratio of a transmission are controlled such that the driving torque of the vehicle V becomes the required driving torque TR, and the opening degree of a throttle valve 56 is controlled such that the engine output torque is generated. The driving control over the engine will be described again later.

On the other hand, when the road is an uphill road, larger driving torque is required to cause the vehicle V to travel as compared to when the road is a flat road. That is, as shown in FIG. 7C, on an uphill road, where the acceleration of gravity is g and a gradient is 0, an acceleration AX (=g·SIN θ) acts on the vehicle V having a mass of M in the direction to move the vehicle V backward. That is, a deceleration AX (=g·SIN θ) acts on the vehicle V. At this time, where C is constant, the required driving torque TR of the vehicle V, which is required so as not for the vehicle V to move backward, is expressed by C·AX (=F·r=M·AX·r). Therefore, when the vehicle V is traveling on an uphill road, the required driving torque TR of the vehicle V is increased by the driving torque C·AX.

Therefore, in the example shown in FIG. 7A, the required driving torque TR of the vehicle V is increased in the course of a period from time t=0 to time t=Δt during which the vehicle V is accelerated, the required driving torque TR of the vehicle V is slightly reduced in the course of a period from time t=Δt to time t=3Δt during which the vehicle V is traveling on a flat road at a constant speed, the required driving torque TR of the vehicle V is significantly increased in the course of a period from time t=3Δt to time t=5Δt during which the vehicle V is traveling on an uphill road at a constant speed, the required driving torque TR of the vehicle V is reduced in the course of a period from time t=5Δt to time t=7Δt during which the vehicle V is traveling on a flat road at a constant speed as compared to when the vehicle V is traveling on the uphill road at a constant speed, and the required driving torque TR of the vehicle V is further reduced from time t=7Δt after which the vehicle V is traveling on a downhill road at a slightly decreased constant speed.

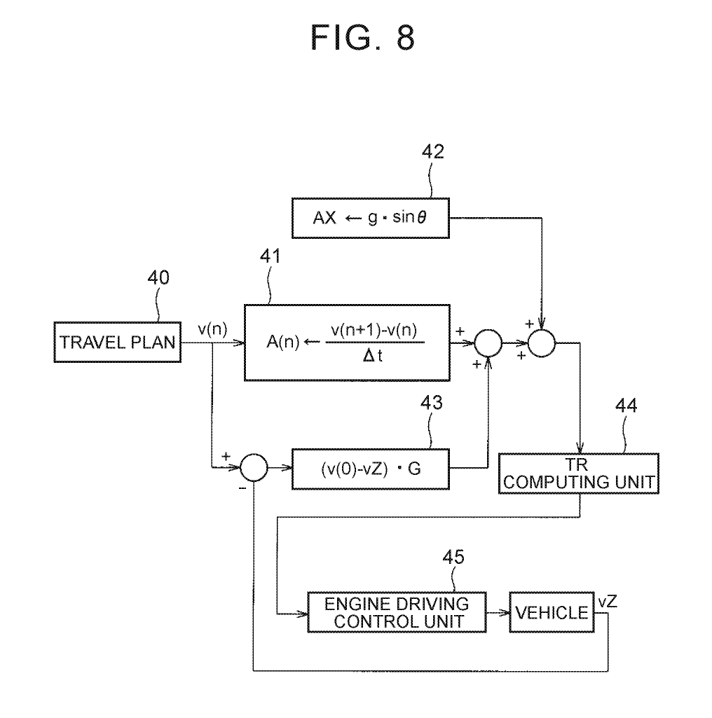

FIG. 8 shows the control structure of engine driving control based on a vehicle travel plan. Where a current (time t=0) vehicle speed generated on the basis of a travel plan 40 is v(0), in the embodiment according to the invention, feedforward control for controlling the vehicle speed at time t=Δt after a lapse of a period of time Δt to a vehicle speed v(1) generated on the basis of the travel plan 40 and feedback control for controlling an actual vehicle speed to a vehicle speed v generated on the basis of the travel plan 40 are executed in parallel with each other at the same time. In this case, it is difficult to understand these feedforward control and feedback control when these controls will be described at the same time, so the feedforward control will be described first, and then the feedback control will be described.

As shown in FIG. 8, a feedforward control unit 41 computes an acceleration A(1)=(v(2)−v(1))/Δt in the traveling direction of the vehicle V at the time when the vehicle speed changes from v(0) to v(1) on the basis of the current (time t=0) vehicle speed v(0) generated on the basis of the travel plan 40, and the vehicle speed v(1) at time t=Δt. On the other hand, a gradient correction unit 43 computes an acceleration AX (=g·SIN θ) on an uphill road or a downhill road, described with reference to FIG. 7C. The acceleration A(1) obtained by the feedforward control unit 41 and the acceleration AX obtained by the gradient correction unit 43 are added together, and a required driving torque TR computing unit 44 computes the required driving torque TR of the vehicle V from the sum (A(1)+AX) of the acceleration A(1) obtained by the feedforward control unit 41 and the acceleration AX obtained by the gradient correction unit 43.

The sum (A(1)+AX) of the accelerations indicates an acceleration required to change the vehicle speed from v(0) to v(1). Therefore, when the required driving torque TR of the vehicle V is changed on the basis of the sum (A(1)+AX) of the accelerations, the calculated vehicle speed at time t=Δt is v(1). Therefore, subsequently, an engine driving control unit 45 executes driving control over the engine such that the driving torque of the vehicle V becomes the required driving torque TR. Thus, the vehicle undergoes automatic driving. In this way, when the required driving torque TR of the vehicle is changed on the basis of the sum (A(1)+AX) of accelerations, the calculated vehicle speed at time t=Δt is v(1). However, the actual vehicle speed deviates from v(1), and the feedback control is executed in order to eliminate the deviation.

That is, a feedback control unit 42 executes feedback control over the required driving torque TR of the vehicle V such that a difference (=v(0)−vz) between the current vehicle speed v(0), generated on the basis of the travel plan 40, and the actual vehicle speed vz becomes zero, that is, the actual vehicle speed vz becomes the current vehicle speed v(0) generated on the basis of the travel plan 40. Specifically, the feedback control unit 42 computes a value (v(0)−vz)·G obtained by multiplying a preset gain G by the difference (=v(0)−vz) between the current vehicle speed v(0) and the actual vehicle speed vz, and adds the value (v(0)−vz)·G obtained by the feedback control unit 42 to the acceleration A(1) obtained by the feedforward control unit 41.

In this way, the actual vehicle speed vz is controlled to the vehicle speed v(n) generated on the basis of the travel plan 40. The vehicle speeds v(0), v(1), v(2), . . . at time t=0, time t=Δt, time t=2Δt, . . . are generated in the travel plan 40. The feedforward control unit 41 computes the accelerations A(1), A(2), A(3), . . . in the traveling direction of the vehicle V at time t=0, time t=Δt, time t=2Δt, . . . on the basis of these vehicle speeds v(n). The required driving torque TR computing unit 44 computes the required driving torques TR of the vehicle V at time t=0, time t=Δt, time t=2Δt, . . . on the basis of these accelerations A(1), A(2), A(3), . . . . That is, the required driving torque TR computing unit 44 computes estimated values of the future required driving torque TR at time t=0, time t=Δt, time t=2Δt, . . . .

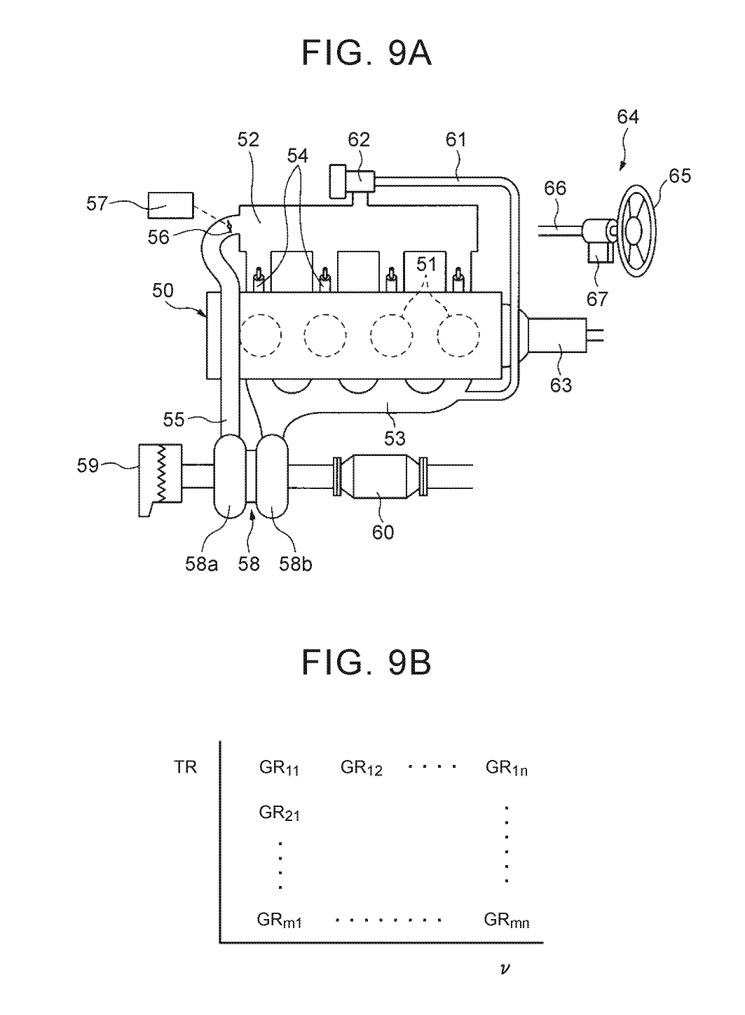

Next, driving control over the engine and driving control over the steering apparatus based on the computed estimated values of the required driving torque TR will be simply described. Before that, an engine portion related to driving control over the engine and the steering apparatus will be described first. FIG. 9A illustrates the entire engine and the steering apparatus. As shown in FIG. 9A, 50 denotes an engine body, 51 denotes combustion chambers, 52 denotes an intake manifold, 53 denotes an exhaust manifold, 54 denotes fuel injection valves respectively arranged in intake branch pipes of the intake manifold 52, 55 denotes an intake air duct, 56 denotes a throttle valve arranged inside the intake air duct 55, 57 denotes an actuator for driving the throttle valve 56, 58 denotes an exhaust gas turbocharger, 59 denotes an air cleaner, 60 denotes a catalytic converter, 61 denotes an exhaust gas recirculation (hereinafter, referred to as EGR) passage that recirculates exhaust gas inside the exhaust manifold 53 into the intake manifold 52, 62 denotes an EGR control valve for controlling an EGR amount, and 63 denotes an automatic transmission connected to the engine body 50.

Intake air is supplied into the combustion chambers 51 via the air cleaner 59, an intake air compressor 58a of the exhaust gas turbocharger 58, the intake air duct 55 and the intake manifold 52. Exhaust gas emitted from the combustion chambers 51 into the exhaust manifold 53 is emitted to the atmosphere via an exhaust gas turbine 58b of the exhaust gas turbocharger 58 and the catalytic converter 60. In FIG. 9A, 64 denotes the steering apparatus. The steering apparatus 64 includes a steering wheel 65, a steering shaft 66 and an electric power steering system 67. The steering shaft 66 is used to transmit the rotational force of the steering wheel 65 to a steering mechanism of steered wheels. When a request to be steered has been issued from the traveling control unit 15, the steering shaft 66 is caused to rotate by driving a steering assist motor of the electric power steering system 67, with the result that steering action is performed.

The automatic transmission 63 shown in FIG. 9A is a stepped automatic transmission or a continuously variable transmission. The speed ratio of the automatic transmission 63 is a function of the required driving torque TR computed by the computing unit 44 in FIG. 8 and the vehicle speed v. The speed ratio GR of the automatic transmission 63 is stored in the ROM of the electronic control unit 10 (FIG. 1) in advance in form of a map shown in FIG. 9B as a function of the required driving torque TR and the vehicle speed v. Roughly speaking, the speed ratio GR of the automatic transmission 63 reduces as the vehicle speed v increases.

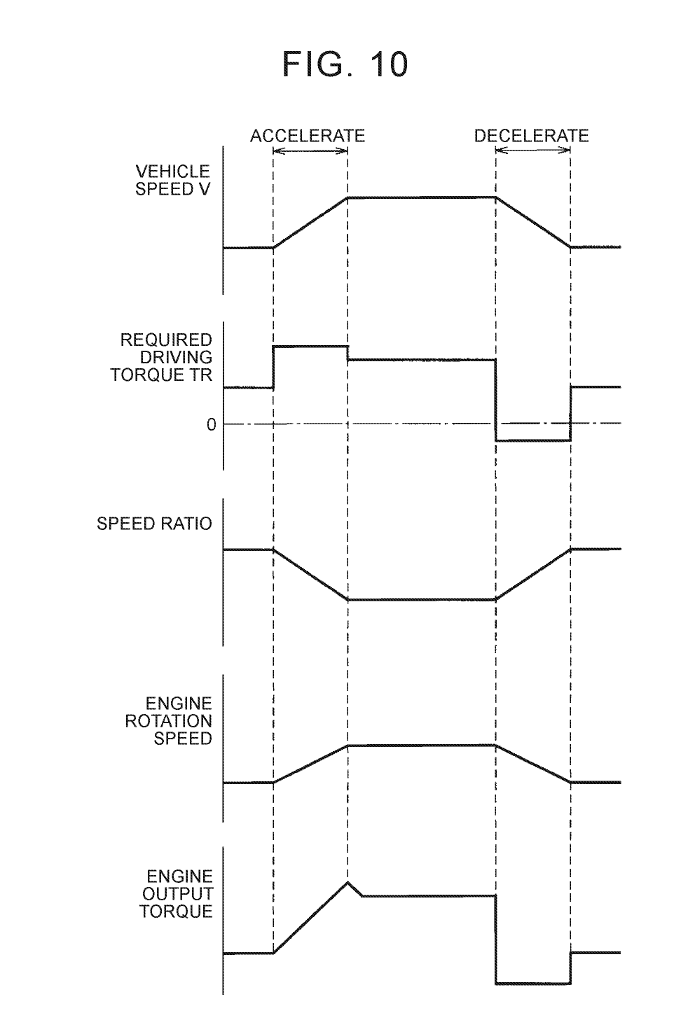

FIG. 10 shows a change in the required driving torque TR, a change in the speed ratio GR of the automatic transmission 63, a change in the engine rotation speed and a change in the engine output torque for a typical change in the vehicle speed v generated on the basis of the travel plan. As shown in FIG. 10, when the vehicle speed v generated on the basis of the travel plan is increased, that is, when the vehicle is accelerated, the required driving torque TR is significantly increased. On the other hand, when the vehicle speed v is increased, the speed ratio GR is gradually reduced, the engine rotation speed is gradually increased and the engine output torque is also gradually increased accordingly. In contrast, when the vehicle speed v generated on the basis of the travel plan is decreased, that is, when the vehicle is decelerated, the required driving torque TR is significantly reduced to a negative value. On the other hand, when the vehicle speed v is decreased, the speed ratio GR is gradually increased, the engine rotation speed is gradually decreased and the engine output torque is reduced to zero or a value close to zero accordingly.

The automatic driving system for a vehicle according to the invention includes the external sensor 1 and the electronic control unit 10. The external sensor 1 is used to detect vehicle peripheral information. The electronic control unit 10 is configured to generate a vehicle travel plan along a target route set in advance on the basis of the map information and the vehicle peripheral information detected by the external sensor 1, and control automatic driving of the vehicle on the basis of the generated vehicle travel plan. In this case, the electronic control unit 10 sets a vehicle target speed on the basis of the generated vehicle travel plan, and the vehicle is caused to travel at the set target speed.

Incidentally, generally speaking, the fuel consumption of the engine is low when the vehicle is caused to travel at a constant speed without being accelerated or decelerated. Therefore, when the vehicle target speed is set, the fuel consumption of the engine is low at the time when the vehicle is caused to travel at the target speed without being accelerated or decelerated. Of course, in this case, it is best to set the vehicle target speed to a speed at which the fuel consumption of the engine is the lowest. Even when it is not possible to set the vehicle target speed to a speed at which the fuel consumption of the engine is the lowest, it is possible to reduce the fuel consumption of the engine if the speed of the vehicle is kept at the target speed.

However, actually, during automatic driving of the vehicle, the speed of the vehicle is not always allowed to be continuously kept at the target speed, and there arises an off-target speed travel duration during which the vehicle needs to be caused to temporarily travel at a speed other than the target speed. If there arises such an off-target speed travel duration, the fuel consumption of the engine during the off-target speed travel duration is usually higher than that in the case where the speed of the vehicle is kept at the target speed. In this case, as the amount of increase in the fuel consumption of the engine at this time is reduced, it is possible to reduce the fuel consumption during automatic driving of the vehicle. On the other hand, in the invention, during automatic driving, vehicle peripheral information is detected by the external sensor 1. Therefore, when the vehicle needs to be caused to temporarily travel at a speed other than the target speed, it is possible to estimate various travel patterns during the off-target speed travel duration on the basis of the vehicle peripheral information.

If it is possible to estimate various travel patterns, it is possible to estimate the amount of increase in the fuel consumption of the engine at the time when the vehicle is caused to travel on the basis of various travel plans for performing these various travel patterns. In this way, if it is possible to estimate the amount of increase in the fuel consumption of the engine at the time when the vehicle is caused to travel on the basis of various travel plans, it is possible to find the travel plan by which the amount of increase in the fuel consumption is minimum among these various travel plans. Therefore, when the vehicle is caused to travel in accordance with the travel plan by which the amount of increase in the fuel consumption is minimum, it is possible to reduce the fuel consumption during automatic driving of the vehicle. In this way, according to the invention, during automatic driving, when the speed of the vehicle is not allowed to be continuously kept at the target speed, the vehicle is caused to travel on the basis of the travel plan by which the amount of increase in the fuel consumption is minimum, thus reducing the fuel consumption during automatic driving of the vehicle.

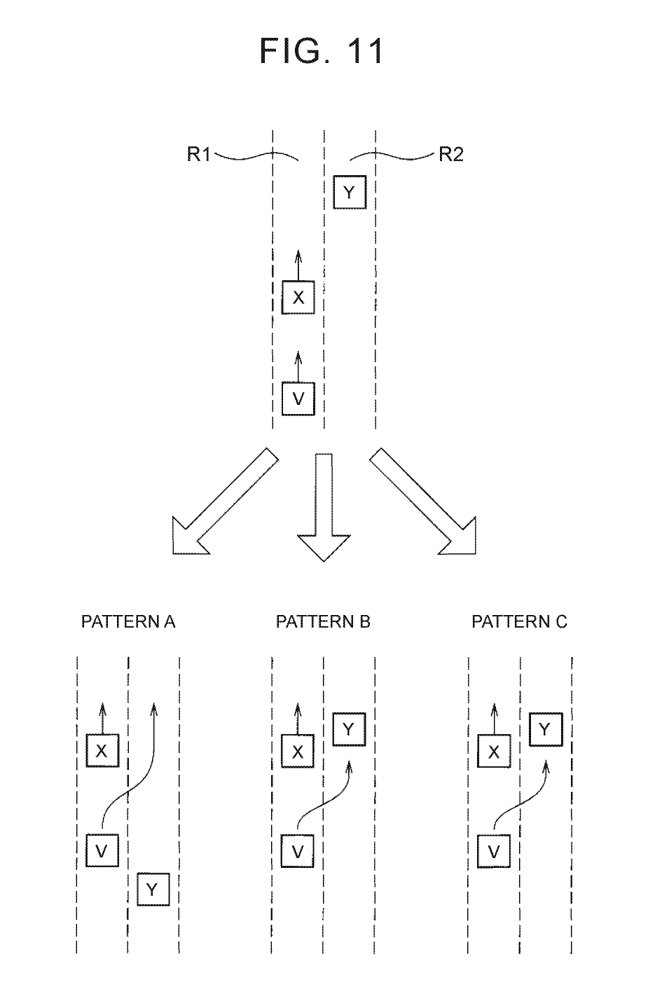

Next, a method of causing the vehicle to travel in accordance with the travel plan by which the amount of increase in the fuel consumption is minimum will be described with reference to a specific example. FIG. 11 shows the case where there are two adjacent cruising lanes R1, R2, the host vehicle V is traveling in the arrow direction in the cruising lane R1, there is another vehicle X ahead of the host vehicle V in the traveling direction of the host vehicle V, and there is another vehicle Y that is stopped in order to turn right in the cruising lane R2. In this case, the positions and movements of the vehicle X and vehicle Y are recognized on the basis of the vehicle peripheral information detected by the external sensor 1.

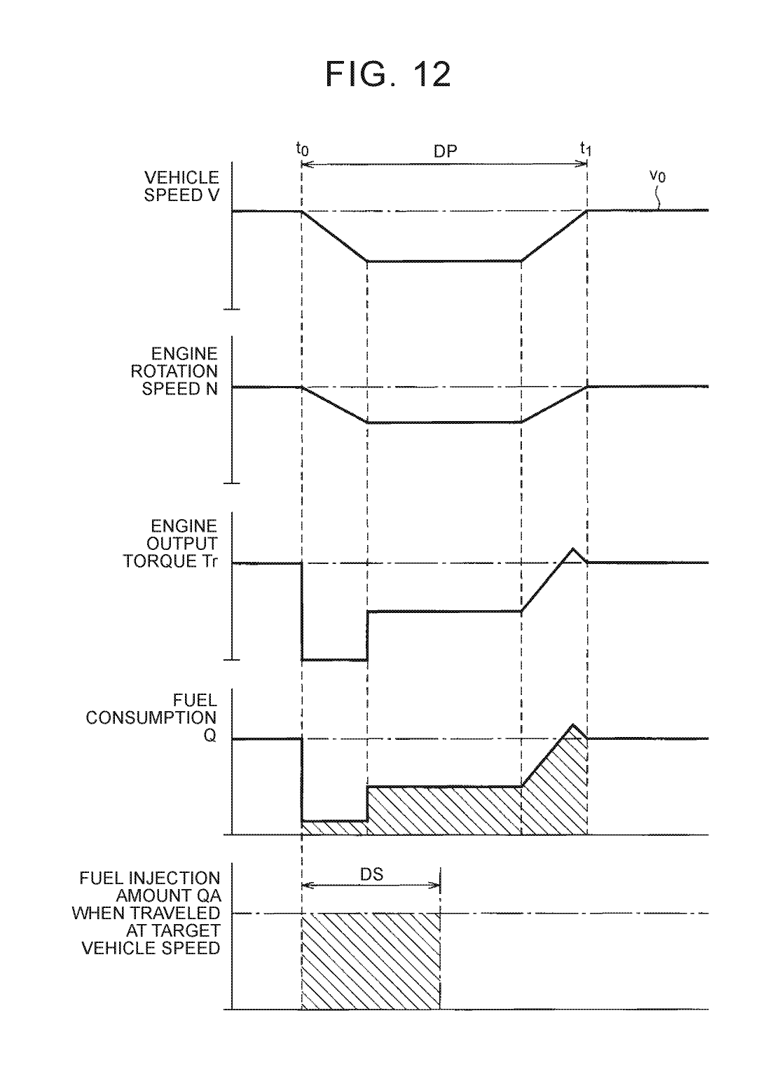

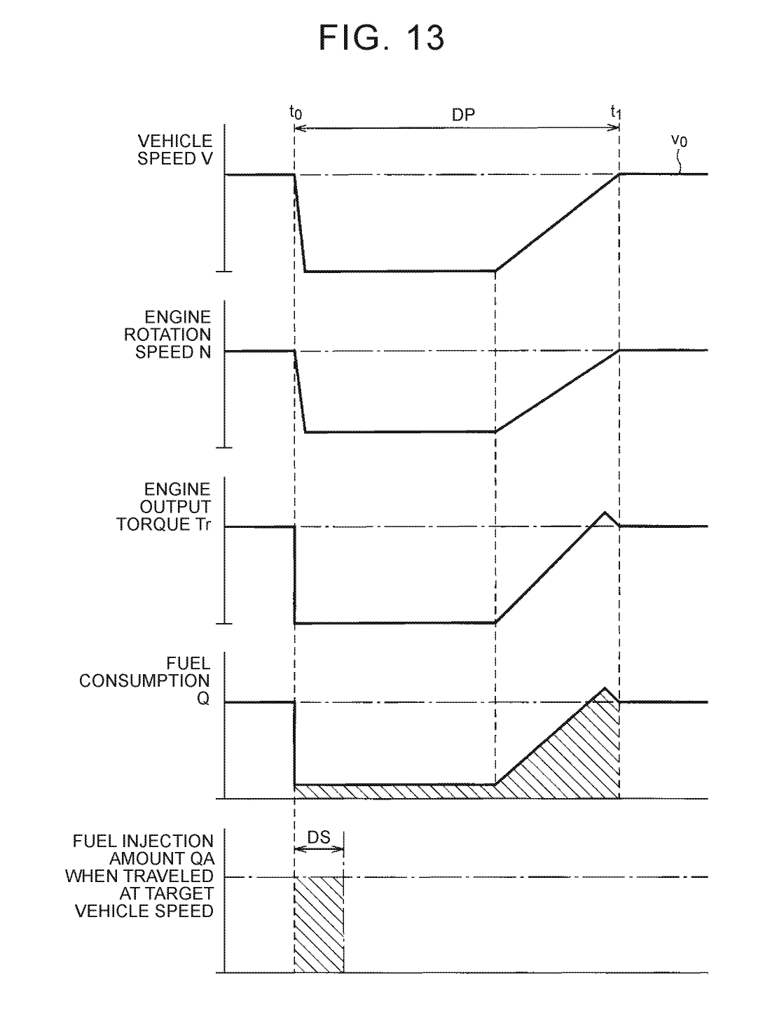

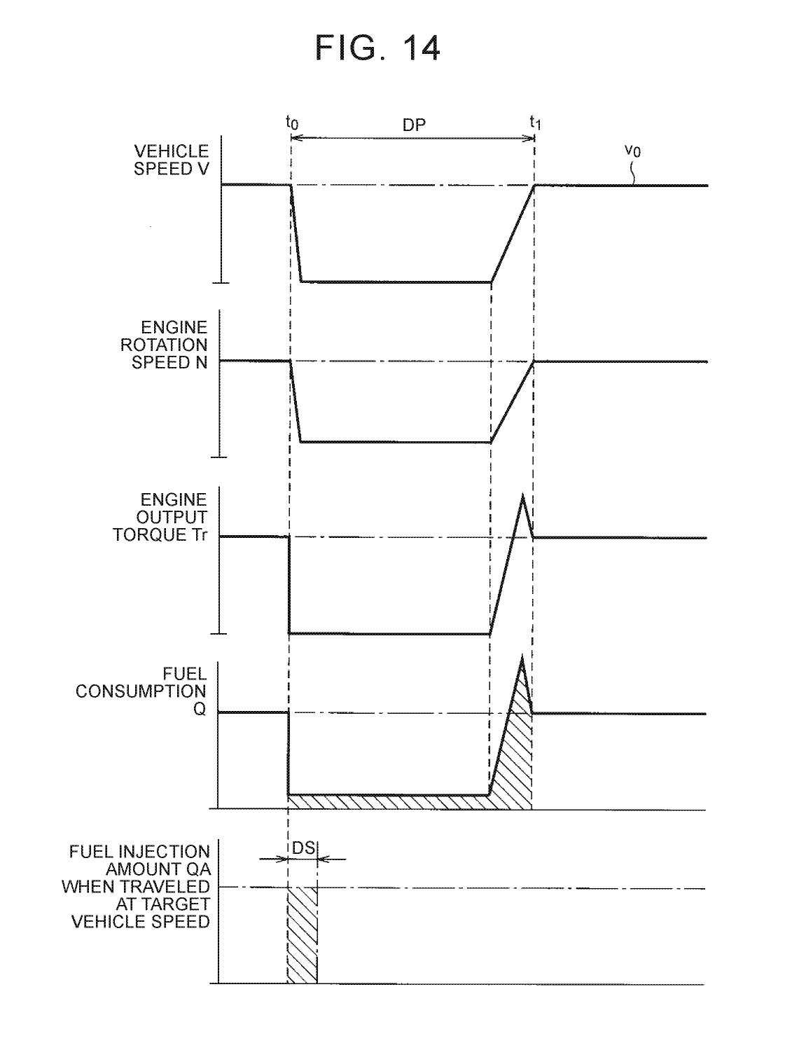

When the vehicle X is traveling at a speed higher than or equal to the target speed of the host vehicle V, there is no problem, and, in this case, the host vehicle V continues to be caused to travel at the target speed. In contrast, when the vehicle X is traveling at a speed lower than the target speed of the host vehicle V or the vehicle X decelerates and travels at a speed lower than or equal to the target speed of the host vehicle V, and, as a result, the host vehicle V is not allowed to keep the target speed any more, a large number of travel patterns that can be taken at this time are estimated from the positions and movements of the vehicle X and vehicle Y. FIG. 11 shows typical three travel patterns that can be taken at this time. A change in the vehicle speed v of the host vehicle V, a change in the engine rotation speed N, a change in the engine output torque and a change in the fuel consumption Q of the engine in each of travel plans for respectively performing the patterns A, B, C in FIG. 11 are shown in a corresponding one of FIG. 12, FIG. 13 and FIG. 14.

The pattern A in FIG. 11 shows the case where the host vehicle V overtakes the stopped vehicle Y and then changes the lane from the cruising lane R1 to the cruising lane R2. Changes in the vehicle speed v, and the like, based on the travel plan at this time are shown in FIG. 12. As shown in the pattern A in FIG. 11 and FIG. 12, in the pattern A, when it is assumed that a distance between the host vehicle V and the vehicle X ahead of the host vehicle V in the traveling direction of the host vehicle V becomes shorter than or equal to a predetermined distance at time t₀ in FIG. 12, the vehicle speed v is gradually decreased thereafter such that the distance between the host vehicle V and the vehicle X is kept at the predetermined distance. When the vehicle speed v is gradually decreased, the engine rotation speed N gradually decreases, the engine output torque Tr decreases to a value close to zero, and the fuel consumption Q of the engine reduces by a large amount. Subsequently, the host vehicle V travels following the vehicle X at the same constant speed as the vehicle X at the predetermined distance from the vehicle X. At this time, the fuel consumption Q of the engine increases in order to increase the engine output torque Tr.

Subsequently, when the host vehicle V overtakes the stopped vehicle Y, the host vehicle V changes the lane from the cruising lane R1 to the cruising lane R2, and subsequently the vehicle speed v is gradually increased so as to become a target speed v₀ of the host vehicle V. As the vehicle speed v is gradually increased, the engine rotation speed N gradually increases, the engine output torque Tr also gradually increases, and the fuel consumption Q of the engine also gradually increases. When the vehicle speed v is gradually increased and, as a result, the host vehicle V overtakes the vehicle X, the host vehicle V changes the lane from the cruising lane R2 to the cruising lane R1. Subsequently, when the vehicle speed v becomes the target speed v₀ at time t₁ in FIG. 12, the host vehicle V is kept at the target speed v₀ again.

In FIG. 12, a period between time t₀ and time t₁ represents an off-target speed travel duration DP during which the host vehicle V needs to be caused to temporarily travel at a speed other than the target speed. The total of the fuel consumption Q of the engine during the off-target speed travel duration DP is expressed by the area of the hatched portion in the fuel consumption Q in FIG. 12. On the other hand, in FIG. 12, DS denotes a travel distance of the host vehicle V during the off-target speed travel duration DP. FIG. 12 shows a fuel consumption QA of the engine on the assumption that the host vehicle V has traveled the travel distance DS at the target speed v₀. The total of the fuel consumption QA of the engine in this case is expressed by the area of the hatched portion in the fuel consumption QA in FIG. 12.

Where the fuel consumption QA of the engine at the time when the host vehicle V is caused to travel at the target speed v₀ is referred to as reference fuel consumption QA and the fuel consumption Q of the engine at the time when the host vehicle V is caused to travel at a speed other than the target speed is referred to as estimated fuel consumption Q, the total of the estimated fuel consumption Q is usually higher than the total of the reference fuel consumption QA. Therefore, it is possible to determine whether the travel plan has low fuel consumption on the basis of the amount of increase in the fuel consumption. In some cases, the total of the estimated fuel consumption Q may be lower than the total of the reference fuel consumption QA. When taking this case into consideration as well, the fuel consumption is the lowest when the amount of increase in the estimated fuel consumption Q with respect to the reference fuel consumption QA is minimum or when the amount of reduction in the estimated fuel consumption Q with respect to the reference fuel consumption QA is maximum.

The pattern B in FIG. 11 shows the case where the host vehicle V changes the lane from the cruising lane R1 to the cruising lane R2 and then lines behind the stopped vehicle Y. Changes in the vehicle speed v, and the like, based on the travel plan at this time are shown in FIG. 13. As shown in the pattern B in FIG. 11 and FIG. 13, in the pattern B, the vehicle speed v of the host vehicle V is rapidly decreased at time t₀ in FIG. 13, and subsequently the host vehicle V is caused to stop after lining behind the vehicle Y. In this case, when the vehicle speed v of the host vehicle V is rapidly decreased, the engine rotation speed N immediately decreases, the engine output torque Tr also immediately reduces to a value close to zero, and the fuel consumption Q of the engine also immediately reduces.

Subsequently, when the vehicle Y turns right and then the vehicle Y disappears from ahead of the host vehicle V, the vehicle speed v is gradually increased so as to become the target speed v₀ of the host vehicle V. When the vehicle speed v is gradually increased, the engine rotation speed N gradually increases, the engine output torque Tr also gradually increases, and the fuel consumption Q of the engine also gradually increases. Subsequently, when the vehicle speed v becomes the target speed v₀ of the host vehicle V at time t₁ in FIG. 13, the host vehicle V is kept at the target speed v₀ again. Subsequently, when the host vehicle V overtakes the vehicle X, the host vehicle V changes the lane from the cruising lane R2 to the cruising lane R1.

In FIG. 13 as well, a period between time t₀ and time t₁ represents an off-target speed travel duration DP during which the host vehicle V needs to be caused to temporarily travel at a speed other than the target speed, and DS denotes a travel distance of the host vehicle V during the off-target speed travel duration DP. The area of the hatched portion in the fuel consumption Q in FIG. 13 represents the total of the fuel consumption Q during the off-target speed travel duration DP, that is, the total of the estimated fuel consumption Q, and the area of the hatched portion in the fuel consumption QA in FIG. 13 represents the total of the fuel consumption QA on the assumption that the host vehicle V has traveled the travel distance DS at the target speed v₀, that is, the total of the reference fuel consumption QA.

The pattern C in FIG. 11, as well as the pattern B, shows the case where the host vehicle V changes the lane from the cruising lane R1 to the cruising lane R2 and then lines behind the stopped vehicle Y. Changes in the vehicle speed v, and the like, based on the travel plan at this time are shown in FIG. 14. As shown in the pattern C in FIG. 11 and FIG. 14, in the pattern C, as well as FIG. 13, the vehicle speed v of the host vehicle V is rapidly decreased at time t₀ in FIG. 14, and subsequently the host vehicle V is caused to stop after lining behind the vehicle Y. In this case, when the vehicle speed v of the host vehicle V is rapidly decreased, the engine rotation speed N immediately decreases, the engine output torque Tr also immediately reduces to a value close to zero, and the fuel consumption Q of the engine also immediately reduces.

Subsequently, when the vehicle Y turns right and then the vehicle Y disappears from ahead of the host vehicle V, the vehicle speed v is gradually increased so as to become the target speed v₀ as shown in FIG. 14. When the vehicle speed v is rapidly increased, the engine rotation speed N also rapidly increases, the engine output torque Tr also rapidly increases, and the fuel consumption Q of the engine also rapidly increases. Subsequently, when the vehicle speed v becomes the target speed v₀ of the host vehicle V at time t₁ in FIG. 14, the host vehicle V is kept at the target speed v₀ again. Subsequently, when the host vehicle V overtakes the vehicle X, the host vehicle V changes the lane from the cruising lane R2 to the cruising lane R1.

In FIG. 14 as well, a period between time t₀ and time t₁ represents an off-target speed travel duration DP during which the host vehicle V needs to be caused to temporarily travel at a speed other than the target speed, and DS denotes a travel distance of the host vehicle V during the off-target speed travel duration DP. The area of the hatched portion in the fuel consumption Q in FIG. 14 represents the total of the fuel consumption Q during the off-target speed travel duration DP, that is, the total of the estimated fuel consumption Q, and the area of the hatched portion in the fuel consumption QA in FIG. 14 represents the total of the fuel consumption QA on the assumption that the host vehicle V has traveled the travel distance DS at the target speed v₀, that is, the total of the reference fuel consumption QA.

Generally speaking, when the vehicle speed v is rapidly increased as show in FIG. 14, the fuel consumption Q increases as compared to the case where the vehicle speed v is gradually increased as shown in FIG. 13. However, when the vehicle speed v is rapidly increased as shown in FIG. 14, the off-target speed travel duration DP becomes shorter, and the travel distance DS of the host vehicle V during the off-target speed travel duration DP becomes shorter. Therefore, it is not clear that the amount of increase in the estimated fuel consumption Q with respect to the reference fuel consumption QA is smaller or the amount of reduction in the estimated fuel consumption Q with respect to the reference fuel consumption QA is larger, in which one of the case shown in FIG. 13 and the case shown in FIG. 14.

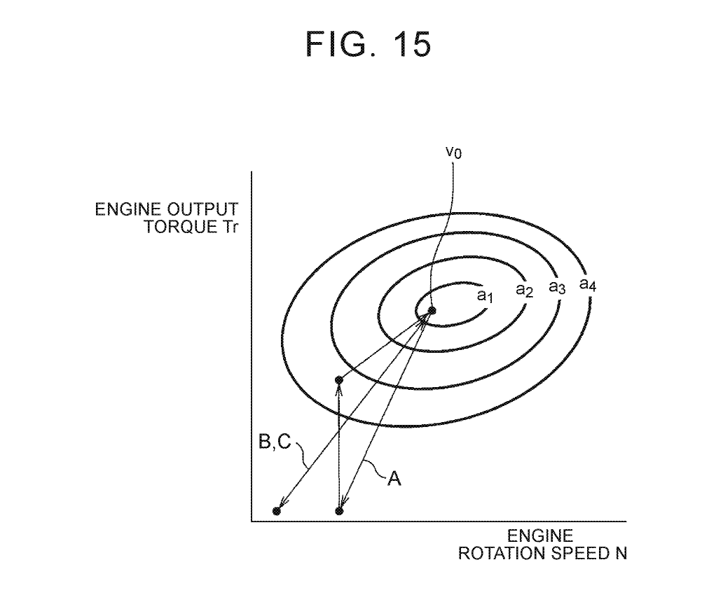

FIG. 15 shows equal fuel consumption lines per unit travel distance. In FIG. 15, the equal fuel consumption line a₁ indicates the case where the fuel consumption is the lowest. The fuel consumption gradually increases in order of the equal fuel consumption lines a₂, a₃, a₄. In FIG. 15, point v₀ indicates a fuel consumption per unit travel distance at the time when the host vehicle V is caused to travel at the target speed v₀. Therefore, in the example shown FIG. 15, the fuel consumption per unit travel distance at the time when the host vehicle V is caused to travel at the target speed v₀ is the lowest. In FIG. 15, A indicates a change in the fuel consumption per unit travel distance at the time when the vehicle speed v is controlled on the basis of the pattern A in FIG. 11 and the travel plan shown in FIG. 12, B indicates a change in the fuel consumption per unit travel distance at the time when the vehicle speed v is controlled on the basis of the pattern B in FIG. 11 and the travel plan shown in FIG. 13, and C indicates a change in the fuel consumption per unit travel distance at the time when the vehicle speed v is controlled on the basis of the pattern C in FIG. 11 and the travel plan shown in FIG. 14.

As described above, the travel plans shown in FIG. 12 to FIG. 14 are typical travel plans, and a large number of travel plans other than these travel plans are generated. For example, various travel plans are generated, and a travel plan by which the fuel consumption during the off-target speed travel duration DP is the lowest is selected from among these travel plans. The various travel plans include, for example, a travel plan in which fuel injection from the fuel injection valves 54 is stopped at the time when the vehicle speed v is decreased in FIG. 12 to FIG. 14, a travel plan in which, at the time when the host vehicle V is stopped, the operation of the engine is temporarily stopped until the host vehicle V is caused to travel as shown in FIG. 13 and FIG. 14, and a travel plan in which the vehicle is caused to coast without driving force that is generated by the engine at the time when the vehicle speed v is kept constant during the off-target speed travel duration DP in FIG. 12.

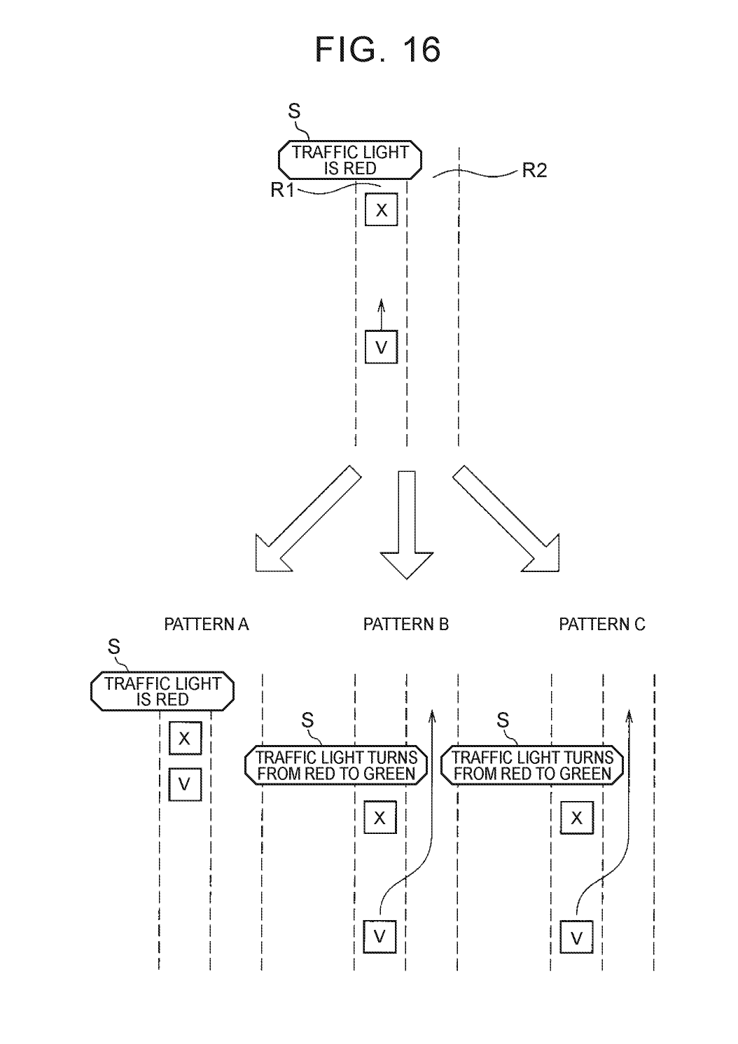

Next, another specific example of a method of causing the vehicle to travel in accordance with the travel plan by which the amount of increase in the fuel consumption is minimum will be described. This example shows the case where a traffic light arranged at a road generates a signal regarding time at which the traffic light turns from red to green and time at which the traffic light turns from green to red, and a travel plan is generated on the basis of the signal. This example also shows the case where there are two adjacent cruising lanes R1, R2, the host vehicle V is traveling in the arrow direction in the cruising lane R1, there is another vehicle X ahead of the host vehicle V in the traveling direction of the host vehicle V, and the vehicle X is stopped at a traffic light S because the traffic light S is red as shown in FIG. 16. In this case, the signal regarding time at which the traffic light S turns from red to green and time at which the traffic light S turns from green to red and the position and movement of the vehicle X are recognized on the basis of the vehicle peripheral information detected by the external sensor 1.

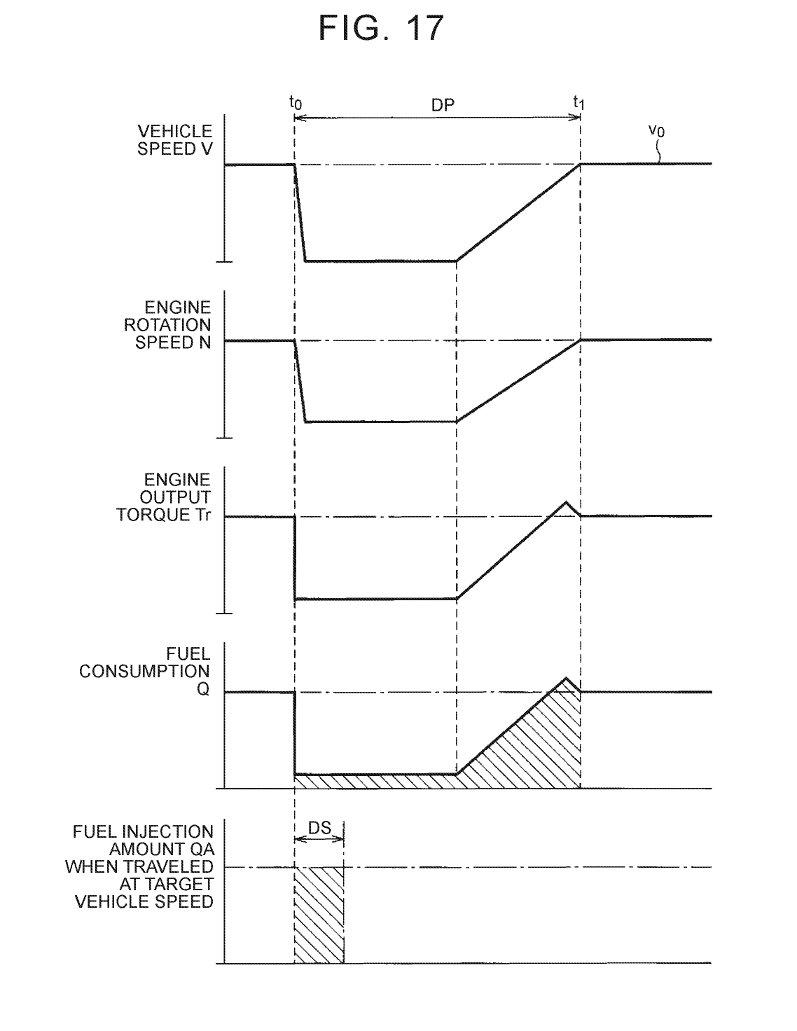

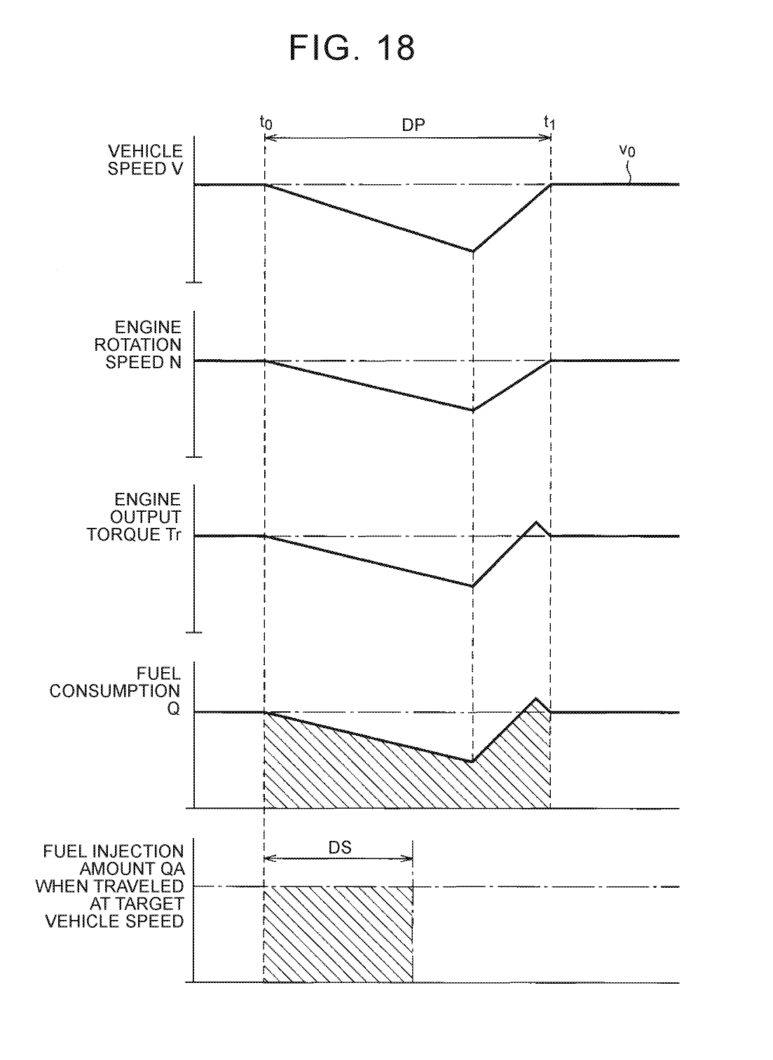

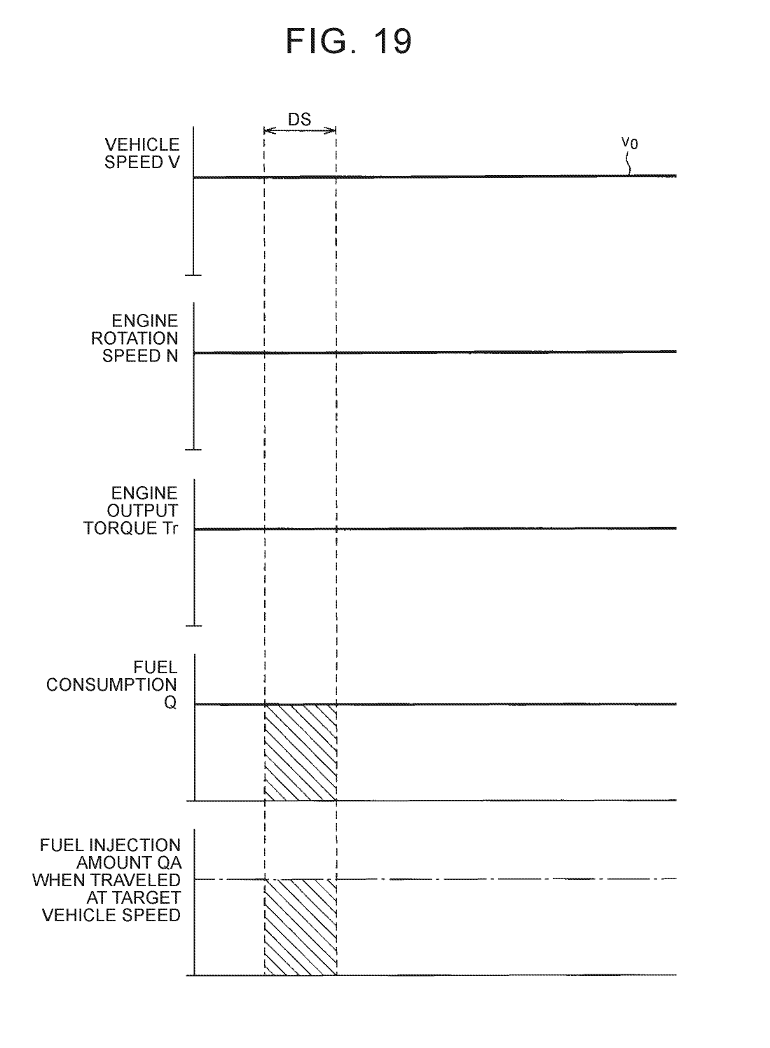

FIG. 16 shows typical three travel patterns A, B, C that can be taken at this time on the basis of time at which the traffic light S turns from red to green. A change in the vehicle speed v of the host vehicle V, a change in the engine rotation speed N, a change in the engine output torque and a change in the fuel consumption Q of the engine in each of travel plans for respectively performing the patterns A, B, C in FIG. 16 are shown in a corresponding one of FIG. 17, FIG. 18 and FIG. 19.

The pattern A in FIG. 16 shows a travel plan at the time when it is recognized that it takes a certain time or longer for the traffic light S to turn from red to green. In this case, the vehicle V is caused to stop behind the stopped vehicle X, and the host vehicle V starts traveling at the time when the vehicle X starts traveling. Changes in the vehicle speed v, and the like, based on the travel plan in this case are shown in FIG. 17. As shown in the pattern A in FIG. 16 and FIG. 17, in the pattern A, the vehicle speed v of the host vehicle V is rapidly decreased at time t₀ in FIG. 17, and then the host vehicle V is caused to stop behind the vehicle X. When the vehicle speed v is rapidly decreased, the engine rotation speed N rapidly decreases, the engine output torque Tr decreases to a value close to zero, and the fuel consumption Q of the engine decreases by a large amount.

Subsequently, when the traffic light S turns from red to green and the vehicle X starts traveling, the vehicle speed v of the host vehicle V is gradually increased so as to become the target speed v₀. When the vehicle speed v is gradually increased, the engine rotation speed N gradually increases, the engine output torque Tr also gradually increases, and the fuel consumption Q of the engine also gradually increases.

Subsequently, when the vehicle speed v becomes the target speed v₀ at time t₁ in FIG. 17, the host vehicle V is kept at the target speed v₀ again.

In FIG. 17 as well, a period between time t₀ and time t₁ represents an off-target speed travel duration DP during which the host vehicle V needs to be caused to temporarily travel at a speed other than the target speed, and DS denotes a travel distance of the host vehicle V during the off-target speed travel duration DP. The area of the hatched portion in the fuel consumption Q in FIG. 17 represents the total of the fuel consumption Q during the off-target speed travel duration DP, that is, the total of the estimated fuel consumption Q, and the area of the hatched portion in the fuel consumption QA in FIG. 17 represents the total of the fuel consumption QA on the assumption that the host vehicle V has traveled the travel distance DS at the target speed v₀, that is, the total of the reference fuel consumption QA.

The pattern B in FIG. 16 shows the travel plan at the time when it is recognized that the traffic light S turns from red to green by the time the host vehicle V reaches the traffic light S when the host vehicle V is slightly decelerated. In this case, the host vehicle V is decelerated, and the host vehicle V changes the lane from the cruising lane R1 to the cruising lane R2. Changes in the vehicle speed v, and the like, based on the travel plan in this case are shown in FIG. 18. As shown in the pattern B in FIG. 16 and FIG. 18, in the pattern B, the vehicle speed v of the host vehicle V is gradually decreased at time t₀ in FIG. 18. When the vehicle speed v is gradually decreased, the engine rotation speed N gradually decreases, the engine output torque Tr also gradually decreases, and the fuel consumption Q of the engine also gradually reduces.

Subsequently, when the traffic light S turns from red to green, the vehicle speed v of the host vehicle V is gradually increased so as to become the target speed v₀.

When the vehicle speed v is gradually increased, the engine rotation speed N gradually increases, the engine output torque Tr also gradually increases, and the fuel consumption Q of the engine also gradually increases. Subsequently, when the vehicle speed v becomes the target speed v₀ at time t₁ in FIG. 18, the host vehicle V is kept at the target speed v₀ again.

In FIG. 18 as well, a period between time t₀ and time t₁ represents an off-target speed travel duration DP during which the host vehicle V needs to be caused to temporarily travel at a speed other than the target speed, and DS denotes a travel distance of the host vehicle V during the off-target speed travel duration DP. The area of the hatched portion in the fuel consumption Q in FIG. 18 represents the total of the fuel consumption Q during the off-target speed travel duration DP, that is, the total of the estimated fuel consumption Q, and the area of the hatched portion in the fuel consumption QA in FIG. 18 represents the total of the fuel consumption QA on the assumption that the host vehicle V has traveled the travel distance DS at the target speed v₀, that is, the total of the reference fuel consumption QA.

The pattern C in FIG. 19 shows the travel plan at the time when it is recognized that the traffic light S turns from red to green before the host vehicle V reaches the traffic light S. In this case, the host vehicle V changes the lane from the cruising lane R1 to the cruising lane R2 while keeping the target speed v₀. Changes in the vehicle speed v, and the like, based on the travel plan in this case are shown in FIG. 19. As shown in the pattern C in FIG. 16 and FIG. 19, in the pattern C, the host vehicle V continues to be kept at the target speed v₀.

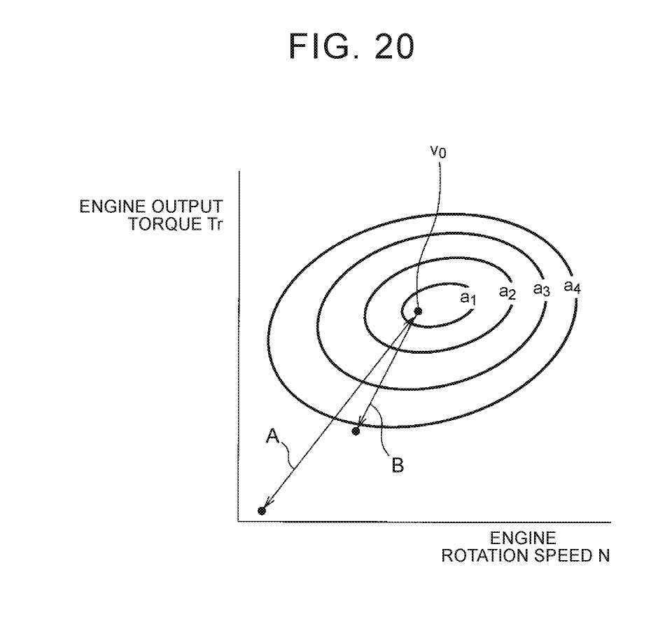

FIG. 20 shows equal fuel consumption lines per unit travel distance as well as FIG. 15. In FIG. 20, as in the case of FIG. 15, the fuel consumption gradually increases in order of the equal fuel consumption lines a₁, a₂, a₃, a₄. In FIG. 20, point v₀ indicates a fuel consumption per unit travel distance at the time when the host vehicle V is caused to travel at the target speed v₀. In FIG. 20, A indicates a change in the fuel consumption per unit travel distance at the time when the vehicle speed v is controlled on the basis of the pattern A in FIG. 16 and the travel plan shown in FIG. 17, and B indicates a change in the fuel consumption per unit travel distance at the time when the vehicle speed v is controlled on the basis of the pattern B in FIG. 16 and the travel plan shown in FIG. 18. In this example as well, the travel plans shown in FIG. 17 and FIG. 18 are typical travel plans, and a large number of travel plans during the off-target speed travel duration DP are generated other than these travel plans.

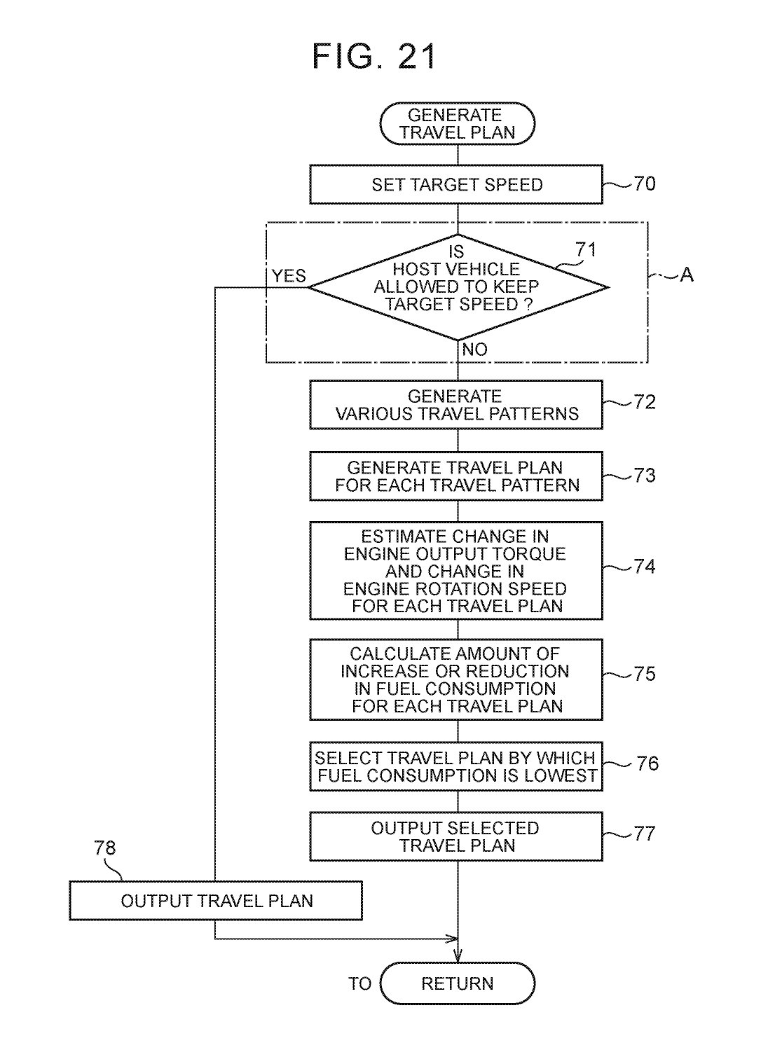

FIG. 21 shows the routine of generating a travel plan, which is executed in step 23 of FIG. 5, for the purpose of implementing the invention. As shown in FIG. 21, initially in step 70, a travel plan is generated on the basis of the position of the host vehicle V, recognized in step 20 of FIG. 5, the external condition of the host vehicle V and the accurate position of the host vehicle V, recognized in step 21, and the traveling state of the host vehicle V, recognized in step 22, and then the target speed v₀ of the host vehicle V is set on the basis of the generated travel plan. Subsequently, in step 71, it is estimated whether the external condition of the host vehicle V allows the host vehicle V to keep the target speed v₀ set on the basis of the travel plan or temporarily does not allow the host vehicle V to keep the target speed v₀, and it is determined on the basis of the estimation whether the host vehicle V is allowed to keep the target speed v₀ set on the basis of the travel plan.

When it is determined in step 71 that the host vehicle V is allowed to keep the target speed v₀ set on the basis of the travel plan, the process proceeds to step 78, and the generated travel plan is output. Subsequently, the process proceeds to RETURN in FIG. 5. At this time, automatic driving of the host vehicle V is performed in accordance with the generated travel plan. In contrast, when it is determined in step 71 that the host vehicle V is temporarily not allowed to keep the target speed v₀, the process proceeds to step 72, and a plurality of travel patterns of the vehicle during the off-target speed travel duration DP, for which it is estimated that the host vehicle V is temporarily not allowed to keep the target speed v₀, are generated. Subsequently, in step 73, a plurality of vehicle travel plans for performing these travel patterns are generated.

Subsequently, in step 74, a change in the engine output torque Tr and a change in the engine rotation speed N are estimated for each travel plan. Subsequently, in step 75, the amount of increase in the estimated fuel consumption Q with respect to the reference fuel consumption QA or the amount of reduction in the estimated fuel consumption Q with respect to the reference fuel consumption QA is calculated for each travel plan on the basis of the estimated change in the engine output torque Tr and the estimated change in the engine rotation speed N. Subsequently, in step 76, the travel plan by which the amount of increase in the estimated fuel consumption Q with respect to the reference fuel consumption QA is minimum or the travel plan by which the amount of reduction in the estimated fuel consumption Q with respect to the reference fuel consumption QA is maximum, that is, the vehicle travel plan by which the fuel consumption of the engine is the lowest is selected from among the plurality of vehicle travel plans during the off-target speed travel duration DP.

Subsequently, in step 77, the selected vehicle travel plan is output. When the travel plan of the vehicle is output, driving of the engine and driving of the steering apparatus 64 are controlled in accordance with the selected vehicle travel plan during the estimated off-target speed travel duration DP. That is, the required driving torque TR that provides the traveling state (v) of the host vehicle V according to the selected vehicle travel plan is calculated, and the engine output torque Tr, that is, the opening degree of the throttle valve 56 and the speed ratio GR of the transmission 63, are controlled such that the driving torque of the vehicle V becomes the required driving torque TR.

In this way, according to the invention, it is estimated whether the vehicle peripheral information detected by the external sensor 1 allows the host vehicle V to keep the target speed v₀ set on the basis of the travel plan or temporarily does not allow the host vehicle V to keep the target speed v₀. When it is estimated that the vehicle peripheral information temporarily does not allow the host vehicle V to keep the target speed v₀, the plurality of vehicle travel plans during the off-target speed travel duration DP, for which it is estimated that the vehicle peripheral information temporarily does not allow the host vehicle V to keep the target speed v₀, are generated. The vehicle travel plan by which the fuel consumption of the engine is the lowest is selected from among the plurality of vehicle travel plans during the off-target speed travel duration DP. During the off-target speed travel duration DP, driving of the engine and driving of the steering apparatus 64 are controlled in accordance with the selected vehicle travel plan.

In this case, in the embodiment according to the invention, for each of the vehicle travel plans that are generated at the time when it is estimated that the vehicle peripheral information temporarily does not allow the host vehicle V to keep the target speed v₀, a change in the engine output torque Tr and a change in the engine rotation speed N during the off-target speed travel duration DP are obtained, and the estimated fuel consumption Q during the off-target speed travel duration DP is calculated on the basis of the change in the engine output torque Tr and the change in the engine rotation speed N.

In this case, in the embodiment according to the invention, the travel distance DS of the vehicle during the off-target speed travel duration DP is obtained, the reference fuel consumption QA on the assumption that the host vehicle V has traveled the travel distance DS at the target speed v₀ is obtained, the vehicle travel plan by which the amount of increase in the estimated fuel consumption Q with respect to the reference fuel consumption QA is minimum or the amount of reduction in the estimated fuel consumption Q with respect to the reference fuel consumption QA is maximum is selected, and driving of the engine and driving of the steering apparatus 64 are controlled during the off-target speed travel duration DP in accordance with the selected vehicle travel plan.

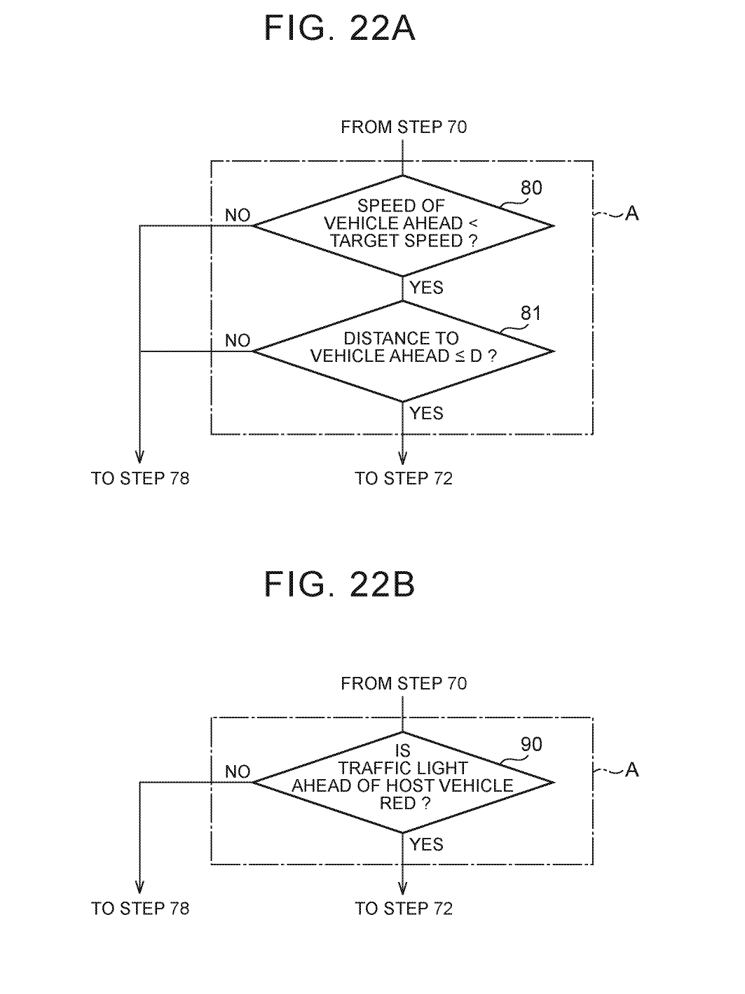

FIG. 22A is a flowchart that shows portion A in FIG. 21 for implementing the example shown in FIG. 11 to FIG. 14. As shown in FIG. 22A, in step 80, it is determined whether the speed of the vehicle X ahead of the host vehicle V in the traveling direction of the host vehicle V is lower than the target speed v₀ of the host vehicle V, that is, whether the host vehicle V is not allowed to travel at the target speed v₀ due to the vehicle X ahead of the host vehicle V in the traveling direction of the host vehicle V. When the speed of the vehicle X ahead of the host vehicle V in the traveling direction of the host vehicle V is equal to the target speed v₀ of the host vehicle V or higher than the target speed v₀ of the host vehicle V, the process proceeds to step 78 in FIG. 21. In contrast, when the speed of the vehicle X ahead of the host vehicle V in the traveling direction of the host vehicle V is lower than the target speed v₀ of the host vehicle V, the process proceeds to step 81. In step 81, it is determined whether the distance between the host vehicle V and the vehicle X ahead of the host vehicle V in the traveling direction of the host vehicle V is shorter than or equal to a predetermined distance D.

In step 81, when the distance between the host vehicle V and the vehicle X ahead of the host vehicle V in the traveling direction of the host vehicle V is not shorter than or equal to the predetermined distance D, the process proceeds to step 78 in FIG. 21. In contrast, when the distance between the host vehicle V and the vehicle X ahead of the host vehicle V in the traveling direction of the host vehicle V is shorter than or equal to the predetermined distance D, the process proceeds to step 72. That is, in the example shown in FIG. 11 to FIG. 14, basically, when the host vehicle V is not allowed to travel at the target speed v₀ due to the vehicle ahead of the host vehicle V in the traveling direction of the host vehicle V, it is estimated that the host vehicle V is temporarily not allowed to keep the vehicle target speed set on the basis of the travel plan. More strictly, when the host vehicle V is not allowed to travel at the target speed v₀ due to the vehicle X ahead of the host vehicle V in the traveling direction of the host vehicle V and when the distance between the host vehicle V and the vehicle X ahead of the host vehicle V in the traveling direction of the host vehicle V is shorter than or equal to the predetermined distance D, it is estimated that the host vehicle V is temporarily not allowed to keep the vehicle target speed set on the basis of the travel plan.

FIG. 22B is a flowchart that shows portion A in FIG. 21 for implementing the example shown in FIG. 16 to FIG. 19. As shown in FIG. 22B, in step 90, it is determined whether the traffic light ahead of the host vehicle V in the traveling direction of the host vehicle V is red. When the traffic light ahead of the host vehicle V in the traveling direction of the host vehicle V is not red, the process proceeds to step 78 in FIG. 21. In contrast, when the traffic light ahead of the host vehicle V in the traveling direction of the host vehicle V is red, the process proceeds to step 72.

In the example shown in FIG. 16 to FIG. 19, when there are at least two adjacent cruising lanes and the host vehicle V is traveling in the cruising lane R1, and when it is estimated that the host vehicle V is temporarily not allowed to keep the target speed v₀ set on the basis of the travel plan, the vehicle travel plan generated at this time includes the travel plan in which the host vehicle V continues to travel in the cruising lane R1 as shown in the pattern A in FIG. 16 and FIG. 17 and the travel plan in which the host vehicle V changes the lane to the cruising lane R2. In the example shown in FIG. 16 to FIG. 19 as well, when the host vehicle V is not allowed to travel at the target speed v₀ due to the vehicle X ahead of the host vehicle V in the traveling direction of the host vehicle V in the cruising lane R1, it is estimated that the host vehicle V is temporarily not allowed to keep the target speed v₀ set on the basis of the travel plan.

What is claimed is:

1. An automatic driving system for a vehicle, comprising:
an external sensor that detects vehicle peripheral information; and
an electronic control unit configured to generate a vehicle travel plan along a preset target route on a basis of map information and the vehicle peripheral information detected by the external sensor, the electronic control unit being configured to control automatic driving of the vehicle on a basis of the vehicle travel plan, the electronic control unit being configured to estimate whether the vehicle peripheral information detected by the external sensor allows the vehicle to keep a vehicle target speed set on a basis of the vehicle travel plan or temporarily does not allow the vehicle to keep the vehicle target speed, the electronic control unit being configured to, when it is estimated that the vehicle peripheral information temporarily does not allow the vehicle to keep the vehicle target speed, generate a plurality of vehicle travel plans during a travel duration for which it is estimated that the vehicle peripheral information temporarily does not allow the vehicle to keep the vehicle target speed, and select one of the plurality of vehicle travel plans, which provides a lowest fuel consumption of an engine, the electronic control unit being configured to, during the travel duration for which it is estimated that the vehicle peripheral information temporarily does not allow the vehicle to keep the vehicle target speed, control driving of the engine and driving of a steering apparatus in accordance with the selected one of the vehicle travel plans.

2. The automatic driving system according to claim 1, wherein
the electronic control unit is configured to, when a host vehicle is not allowed to travel at the vehicle target speed due to another vehicle ahead of the host vehicle in a traveling direction of the host vehicle, estimate that the vehicle peripheral information temporarily does not allow the host vehicle to keep the vehicle target speed set on a basis of the vehicle travel plan.

3. The automatic driving system according to claim 2, wherein
the electronic control unit is configured to, when the host vehicle is not allowed to travel at the vehicle target speed due to the other vehicle ahead of the host vehicle in the traveling direction of the host vehicle and when a distance between the host vehicle and the other vehicle ahead of the host vehicle in the traveling direction of the host vehicle is shorter than or equal to a predetermined distance, estimate that the vehicle peripheral information temporarily does not allow the host vehicle to keep the vehicle target speed set on a basis of the vehicle travel plan.

4. The automatic driving system according to claim 1, wherein
the electronic control unit is configured to, when there are at least two adjacent cruising lanes, a host vehicle is traveling in one of the cruising lanes and it is estimated that the vehicle peripheral information temporarily does not allow the host vehicle to keep the vehicle target speed set on a basis of the vehicle travel plan, generate the vehicle travel plan, including a vehicle travel plan in which the host vehicle continues traveling in the one of the cruising lanes and a vehicle travel plan in which the host vehicle makes a lane change to the other one of the cruising lanes.

5. The automatic driving system according to claim 4, wherein
the electronic control unit is configured to, when the host vehicle is not allowed to travel at the vehicle target speed due to another vehicle ahead of the host vehicle in a traveling direction of the host vehicle in the one of the cruising lanes, estimate that the vehicle peripheral information temporarily does not allow the host vehicle to keep the vehicle target speed set on a basis of the vehicle travel plan.

6. The automatic driving system according to claim 1, wherein
the electronic control unit is configured to generate a vehicle travel plan during the travel duration for which it is estimated that the vehicle peripheral information temporarily does not allow the vehicle to keep the vehicle target speed on a basis of a signal received from a traffic light arranged at a road, the signal regarding time at which the traffic light turns from red to green and time at which the traffic light turns from green to red.

7. The automatic driving system according to claim 1, wherein
the electronic control unit is configured to, for each of the vehicle travel plans, calculate a change in engine output torque and a change in engine rotation speed during the travel duration for which it is estimated that the vehicle peripheral information temporarily does not allow the vehicle to keep the vehicle target speed and then calculate an estimated fuel consumption during the travel duration for which it is estimated that the vehicle peripheral information temporarily does not allow the vehicle to keep the vehicle target speed on a basis of the change in engine output torque and the change in engine rotation speed.

8. The automatic driving system according to claim 7, wherein
the electronic control unit is configured to calculate a vehicle travel distance during the travel duration for which it is estimated that the vehicle peripheral information temporarily does not allow the vehicle to keep the vehicle target speed, the electronic control unit is configured to calculate a reference fuel consumption on an assumption that the vehicle has traveled the vehicle travel distance at the vehicle target speed, the electronic control unit is configured to select one of the vehicle travel plans, by which an amount of increase in estimated fuel consumption with respect to the reference fuel consumption is minimum or an amount of reduction in estimated fuel consumption with respect to the reference fuel consumption is maximum, the electronic control unit is configured to, during the travel duration for which it is estimated that the vehicle peripheral information temporarily does not allow the vehicle to keep the vehicle target speed, control driving of the engine and driving of the steering apparatus in accordance with the selected one of the vehicle travel plans.
